(19) United States
(12) Patent Application Publication
(10) Pub. No.: US 2015/0186821 A1
(43) Pub. Date: Jul. 2, 2015

(54) COMPUTER-IMPLEMENTED METHODS AND SYSTEMS FOR ANALYZING HEALTHCARE DATA

(71) Applicant: PALANTIR TECHNOLOGIES INC., Palo Alto, CA (US)

(72) Inventors: Lekan WANG, Palo Alto, CA (US); Allen CHANG, Mountain View, CA (US); John GARROD, Palo Alto, CA (US); Sina IMAN, Washington, DC (US); Patrick TARDIF, San Carlos, CA (US); Antoine LLORCA, London (GB); Sebastian BRUCKNER, Potsdam (DE); Cody VEAL, Whitby (CA); Samuel FENDELL, East Palo Alto, CA (US); Christopher LEWIS, East Palo Alto, CA (US); Brian NGO, San Francisco, CA (US); Patrick DUNN, Arlington, VA (US); Sebastian CALIRI, Palo Alto, CA (US); Hari ARUL, New York, NY (US); Ajay SUDAN, Menlo Park, CA (US); Michael WINLO, Palo Alto, CA (US); Isaac GATENO, Palo Alto, CA (US); Michael GLAZER, San Francisco, CA (US); Daniel CERVELLI, Mountain View, CA (US); Lauren CHAPARRO, San Francisco, CA (US)

(73) Assignee: PALANTIR TECHNOLOGIES INC., Palo Alto, CA (US)

(21) Appl. No.: 14/289,599

(22) Filed: May 28, 2014

Related U.S. Application Data
(60) Provisional application No. 61/923,187, filed on Jan. 2, 2014.
(60) Provisional application No. 61/923,189, filed on Jan. 2, 2014.

(51) Int. Cl. G06Q 10/06; G06Q 50/22

(52) U.S. Cl. CPC G06Q 10/0639; G06Q 50/22

(57) ABSTRACT

Computer-implemented systems and methods are provided for analyzing healthcare-related entity performance. In one implementation, a method is implemented with one or more processors and includes accessing a data structure including information that specifies healthcare-related interactions and identifying, from the data structure, a first set of interactions associated with a first healthcare-related entity. The method also includes identifying, from the data structure, a second set of interactions associated with one or more filter selections and processing the information of the identified first and second set of interactions to provide performance information of the first healthcare-related entity and one or more healthcare-related entities associated with the one or more filter selections. The method also includes generating a user interface that includes the performance information of the first healthcare-related entity and the one or more healthcare-related entities indicating a performance of the first healthcare-related entity and the one or more healthcare-related entities respectively.

### REFERENCE TO RELATED APPLICATIONS

This application claims the benefit of priority to U.S. Provisional Patent Application No. 61/923,187, filed on Jan. 2, 2014, and to U.S. Provisional Patent Application No. 61/923,189, also filed on Jan. 2, 2014, the disclosures of which are expressly incorporated herein by reference in their entirety

### BACKGROUND

The amount of information being processed and stored is rapidly increasing as technology advances. Today, large volumes of data can be stored in computer-based systems using a variety of structured data stores. For example, one type of data store is a so-called “flat” file such as a spreadsheet, plain-text document, or XML document. Another type of data store is a relational database comprising one or more tables. Other examples of data stores include, without limitation, file systems, object collections, record collections, arrays, hierarchical trees, linked lists, stacks, and combinations thereof.

Numerous organizations, including industry, retail, and government entities, recognize that important information and decisions can be drawn if massive data sets can be analyzed to identify patterns of behavior. Collecting and classifying large sets of data in an appropriate manner allows these entities to more quickly and efficiently identify these patterns, thereby allowing them to make more informed decisions.

### BRIEF DESCRIPTION OF THE DRAWINGS

Reference will now be made to the accompanying drawings which illustrate exemplary embodiments of the present disclosure and in which:

FIG. 1 illustrates, in block diagram form, an exemplary data fusion system for providing interactive data analysis, consistent with embodiments of the present disclosure.

FIG. 2 is a block diagram of an exemplary system for analyzing performance of an entity, consistent with embodiments of the present disclosure.

FIG. 3 is a block diagram of an exemplary computer system, consistent with embodiments of the present disclosure.

FIG. 4 is a block diagram of an exemplary data structure accessed in the process of analyzing entity performance, consistent with embodiments of the present disclosure.

FIG. 5 is a flowchart representing an exemplary process for analyzing entity performance, consistent with embodiments of the present disclosure.

FIGS. 6-14 are block diagrams depicting exemplary user interfaces representing an entity performance, consistent with embodiments of the present disclosure.

FIGS. 15A and 15B are flowcharts representing an exemplary process for comparing entity performance, consistent with embodiments of the present disclosure.

FIGS. 16-18 are block diagrams depicting exemplary user interfaces representing entity performance, consistent with embodiments of the present disclosure.

### DETAILED DESCRIPTION OF EXEMPLARY EMBODIMENTS

This application expressly incorporates herein the entirety of the following documents: U.S. Provisional Patent Application No. 61/916,795, titled “Methods and Systems for Analyzing Entity Performance,” filed on Dec. 16, 2013; U.S. Non-Provisional patent application Ser. No. 14/045,720, titled “Systems and Methods for Analyzing Performance of an Entity,” filed on Oct. 3, 2013; and U.S. Non-Provisional patent application Ser. No. 13/827,491, titled “Resolving Similar Entities from a Transaction Database,” filed on Mar. 14, 2013.

Reference will now be made in detail to the embodiments, the examples of which are illustrated in the accompanying drawings. Whenever possible, the same reference numbers will be used throughout the drawings to refer to the same or like parts.

The following embodiments are generally directed to collecting, processing, analyzing, and displaying information for healthcare-related entities, which can also be referred to in the following embodiments as entities. These entities can include medical provider entities, such as a particular doctor, a doctor's office having one or more doctors, a hospital, etc. The healthcare-related entities can also include pharmacies, such as Walgreens™, CVS Caremark™, etc. Moreover, the healthcare-related entities can include health insurance payers, such as Cigna™, Aetna™, Kaiser Permanente™, etc. The healthcare-related entities can interact with member entities, such as an individual person seeking medical services (e.g., seeking medical advice, prescriptions, pharmaceutical drugs, etc.).

Using the information that is collected, processed, analyzed, and displayed, a number of useful insights associated with healthcare-related entities can be inferred. For example, these insights can relate to: an ability to detect any irregularities such as fraud associated with medical claims and/or prescription claims; an ability by a medical provider entity to be able to analyze and compare its performance with other medical provider entities in a given region; an ability to perform a cohort analysis, where a cohort can be a group of entities that share an attribute. Other forms of insights can include providing a summary of the kinds of medical services being offered by medical provider entities. And, as yet a further example, the insights can include providing a performance comparison between different locations of the same medical provider entity.

The term healthcare-related data can be used to comprise medical claim data, prescription medicine data, pharmacy claim data, clinical data, and the like. The terms interactions, transactions, claims, and medical claims are intended to convey the same meaning and can be used interchangeably throughout this disclosure. In some embodiments, medical claims can be referred to as interactions between various entities involved in healthcare industry. As described herein, interactions can refer to any transaction or communication between two or more healthcare-related entities. For example, interactions can be at least one of: medical claims associated with a member entity, a medical provider entity, and a healthcare insurance provider entity; a prescription associated with a member entity and a medical provider entity; and a pharmaceutical drug transaction associated with a member entity, a medical provider entity, and a pharmacy entity. It is appreciated that other interactions are possible within the scope and spirit of this disclosure.

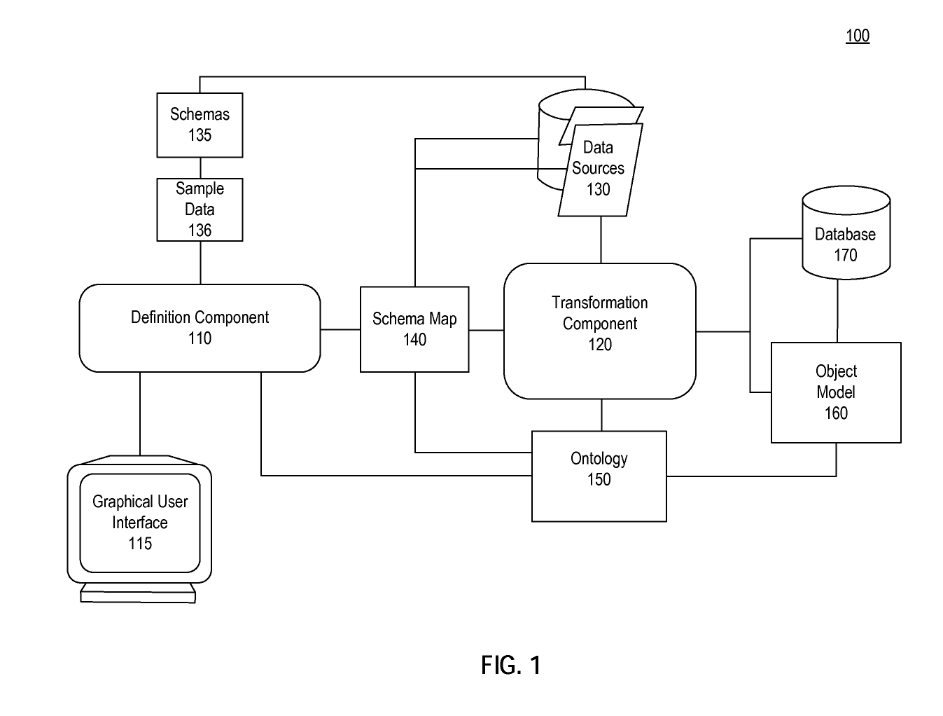

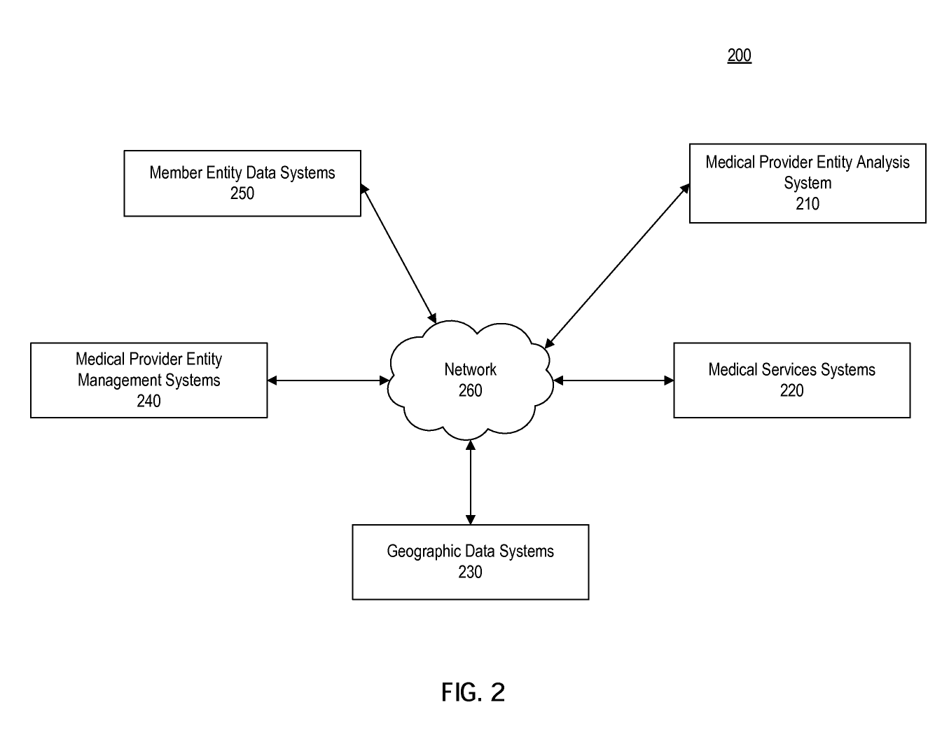

FIG. 1 illustrates, in block diagram form, an exemplary data fusion system 100 for providing interactive data analysis, consistent with embodiments of the present disclosure. Among other things, data fusion system 100 facilitates transformation of one or more data sources, such as data sources 130 (e.g., medical services systems 220, geographic data systems 230, medical provider entity management systems 240 and/or member entity data systems 250, as shown in FIG. 2) into an object model 160 whose semantics are defined by an ontology 150. The transformation can be performed for a variety of reasons. For example, a database administrator can import data from data sources 130 into a database 170 for persistently storing object model 160. As another example, a data presentation component (not depicted) can transform input data from data sources 130 “on the fly” into object model 160. The object model 160 can then be utilized, in conjunction with ontology 150, for analysis through graphs and/or other data visualization techniques.

Data fusion system 100 comprises a definition component 110 and a translation component 120, both implemented by one or more processors of one or more computing devices or systems executing hardware and/or software-based logic for providing various functionality and features of the present disclosure, as described herein. As will be appreciated from the present disclosure, data fusion system 100 can comprise fewer or additional components that provide the various functionalities and features described herein. Moreover, the number and arrangement of the components of data fusion system 100 responsible for providing the various functionalities and features described herein can further vary from embodiment to embodiment.

Definition component 110 generates and/or modifies ontology 150 and a schema map 140. Exemplary embodiments for defining an ontology (such as ontology 150) are described in U.S. Pat. No. 7,962,495 (the '495 patent), issued on Jun. 14, 2011, the entire contents of which are expressly incorporated herein by reference for all purposes. Consistent with certain embodiments disclosed in the '495 patent, a dynamic ontology may be used to create a database. To create a database ontology, one or more object types may be defined, where each object type includes one or more properties. The attributes of object types or property types of the ontology can be edited or modified at any time. And, for each property type, at least one parser definition may be created. The attributes of a parser definition can be edited or modified at any time.

In some embodiments, each property type is declared to be representative of one or more object types. A property type is representative of an object type when the property type is intuitively associated with the object type. Alternatively, each property type has one or more components and a base type. In some embodiments, a property type can comprise a string, a date, a number, or a composite type consisting of two or more string, date, or number elements. Thus, property types are extensible and can represent complex data structures. Further, a parser definition can reference a component of a complex property type as a unit or token.

An example of a property having multiple components is an Address property having a City component and a State component. An example of raw input data is “Los Angeles, Calif.” An example parser definition specifies an association of imported input data to object property components as follows: {CITY}, {STATE}→Address:State, Address:City. In some embodiments, the association {CITY}, {STATE} is defined in a parser definition using regular expression symbology. The association {CITY}, {STATE} indicates that a city string followed by a state string, and separated by a comma, comprises valid input data for a property of type Address. In contrast, input data of “Los Angeles Calif.” would not be valid for the specified parser definition, but a user could create a second parser definition that does match input data of “Los Angeles Calif.” The definition Address:City, Address:State specifies that matching input data values map to components named “City” and “State” of the Address property. As a result, parsing the input data using the parser definition results in assigning the value “Los Angeles” to the Address:City component of the Address property, and the value “CA” to the Address:State component of the Address property.

According to some embodiments, schema map 140 can define how various elements of schemas 135 for data sources 130 map to various elements of ontology 150. Definition component 110 receives, calculates, extracts, or otherwise identifies schemas 135 for data sources 130. Schemas 135 define the structure of data sources 130; for example, the names and other characteristics of tables, files, columns, fields, properties, and so forth. Definition component 110 furthermore optionally identifies sample data 136 from data sources 130. Definition component 110 can further identify object type, relationship, and property definitions from ontology 150, if any already exist. Definition component 110 can further identify pre-existing mappings from schema map 140, if such mappings exist.

Based on the identified information, definition component 110 can generate a graphical user interface 115. Graphical user interface 115 can be presented to users of a computing device via any suitable output mechanism (e.g., a display screen, an image projection, etc.), and can further accept input from users of the computing device via any suitable input mechanism (e.g., a keyboard, a mouse, a touch screen interface, etc.). Graphical user interface 115 features a visual workspace that visually depicts representations of the elements of ontology 150 for which mappings are defined in schema map 140.

In some embodiments, transformation component 120 can be invoked after schema map 140 and ontology 150 have been defined or redefined. Transformation component 120 identifies schema map 140 and ontology 150. Transformation component 120 further reads data sources 130 and identifies schemas 135 for data sources 130. For each element of ontology 150 described in schema map 140, transformation component 120 iterates through some or all of the data items of data sources 130, generating elements of object model 160 in the manner specified by schema map 140. In some embodiments, transformation component 120 can store a representation of each generated element of object model 160 in a database 170. In some embodiments, transformation component 120 is further configured to synchronize changes in object model 160 back to data sources 130.

Data sources 130 can be one or more sources of data, including, without limitation, spreadsheet files, databases, email folders, document collections, media collections, contact directories, and so forth. Data sources 130 can include data structures stored persistently in non-volatile memory. Data sources 130 can also or alternatively include temporary data structures generated from underlying data sources via data extraction components, such as a result set returned from a database server executing an database query.

Schema map 140, ontology 150, and schemas 135 can be stored in any suitable structures, such as XML files, database tables, and so forth. In some embodiments, ontology 150 is maintained persistently. Schema map 140 can or cannot be maintained persistently, depending on whether the transformation process is perpetual or a one-time event. Schemas 135 need not be maintained in persistent memory, but can be cached for optimization.

Object model 160 comprises collections of elements such as typed objects, properties, and relationships. The collections can be structured in any suitable manner. In some embodiments, a database 170 stores the elements of object model 160, or representations thereof. Alternatively, the elements of object model 160 are stored within database 170 in a different underlying format, such as in a series of object, property, and relationship tables in a relational database.

According to some embodiments, the functionalities, techniques, and components described herein are implemented by one or more special-purpose computing devices. The special-purpose computing devices can be hard-wired to perform the techniques, or can include digital electronic devices such as one or more application-specific integrated circuits (ASICs) or field programmable gate arrays (FPGAs) that are persistently programmed to perform the techniques, or can include one or more general purpose hardware processors programmed to perform the techniques pursuant to program instructions in firmware, memory, other storage, or any combination thereof. Such special-purpose computing devices can also combine custom hard-wired logic, ASICs, or FPGAs with custom programming to accomplish the techniques. The special-purpose computing devices can be desktop computer systems, portable computer systems, handheld devices, networking devices, or any other device that incorporates hard-wired and/or program logic to implement the techniques.

Throughout this disclosure, reference will be made to an entity such as, for example, a medical provider entity and a member entity. It is appreciated that a medical provider entity can include, for example, a medical professional such as a doctor, a hospital, or a medical clinic or the like, and a member entity can include, for example, an individual person seeking medical services (e.g., seeking medical advice, prescriptions, pharmaceutical drugs, etc.) from a medical provider entity. It is appreciated that a member entity can represent either individual persons or can represent a group of persons (e.g., a group of persons living under one roof as part of a family). In some embodiments, a member entity can be represented by a number of an individual or a number for an entire family. It will also be understood that a medical provider entity can represent either the entity itself or individual persons involved with the entity.

In embodiments described herein, data fusion system 100 can provide a medical provider entity, such as a hospital, or a third-party, such as a health insurance payer entity, to analyze information to analyze performance of the medical provider entity and also to compare the medical provider entity's performance with other medical provider entities. Also, a health insurance payer entity can analyze medical claims associated with a particular medical provider entity to detect any possible fraud associated with the provider entity. Additionally, medical provider entitles can evaluate its performance using comparative analysis.

FIG. 2 is a block diagram of an exemplary system 200 for performing one or more operations for analyzing performance of a medical provider entity and/or a member entity, consistent with disclosed embodiments. In some embodiments, the medical provider entity can be a doctor and system 200 can include one or more medical provider entity analysis systems 210, one or more medical services systems 220, one or more geographic data systems 230, one or more medical provider entity management systems 240, and one or more member entity data systems 250. The components and arrangement of the components included in system 200 can vary depending on the embodiment. For example, the functionality described below with respect to medical services systems 220 can be embodied in member entity data systems 250, or vice-versa. Also, system 200 can include fewer or additional components that perform or assist in the performance of one or more processes to analyze medical provider entity's, consistent with the disclosed embodiments.

One or more components of system 200 can be computing systems configured to analyze medical provider entity performance. As further described herein, components of system 200 can include one or more computing devices (e.g., computer(s), server(s), etc.), memory storing data and/or software instructions (e.g., database(s), memory devices, etc.), and other known computing components. In some embodiments, the one or more computing devices are configured to execute software or a set of programmable instructions stored on one or more memory devices to perform one or more operations, consistent with the disclosed embodiments. Components of system 200 can be configured to communicate with one or more other components of system 200, including one or more medical provider entity analysis systems 210, one or more medical services systems 220, one or more geographic data systems 230, one or more medical provider entity management systems 240, and one or more member entity data systems 250. In certain aspects, users can operate one or more components of system 200. The one or more users can be employees of, or associated with, an entity corresponding to the respective component(s) (e.g., someone authorized to use the underlying computing systems or otherwise act on behalf of the entity).

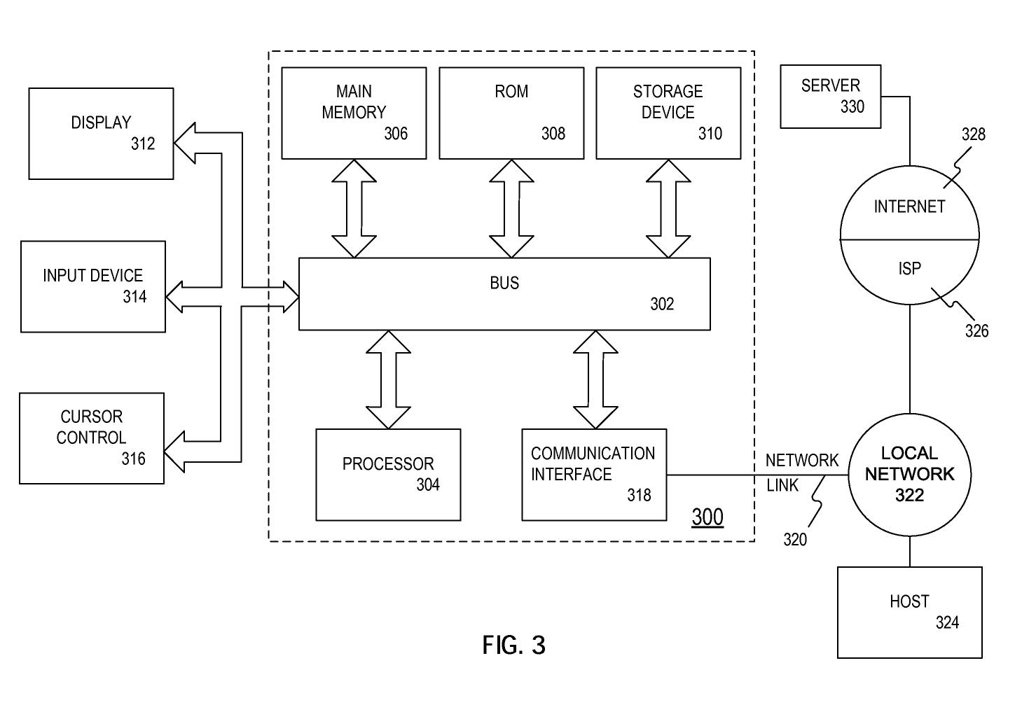

Medical provider entity analysis system 210 can be a computing system configured to analyze medical provider entity performance. For example, medical provider entity analysis system 210 can be a computer system configured to execute software or a set of programmable instructions that collect or receive medical interaction data, member entity data, and medical provider entity data and process it to determine various insights associated with the medical provider entity or a member entity. Medical provider entity analysis system 210 can be configured, in some embodiments, to utilize, include, or be a data fusion system 100 (see, e.g., FIG. 1) to transform data from various data sources (such as, medical services systems 220, geographic data systems 230, medical provider entity management systems 240, and member entity data systems 250) for processing. In some embodiments, medical provider entity analysis system 210 can be implemented using a computer system 300, as shown in FIG. 3 and described below.

Medical provider entity analysis system 210 can include one or more computing devices (e.g., server(s)), memory storing data and/or software instructions (e.g., database(s), memory devices, etc.) and other known computing components. According to some embodiments, medical provider entity analysis system 210 can include one or more networked computers that execute processing in parallel or use a distributed computing architecture. Medical provider entity analysis system 210 can be configured to communicate with one or more components of system 200, and it can be configured to provide analysis of medical provider entities via an interface(s) accessible by users over a network (e.g., the Internet). For example, medical provider entity analysis system 210 can include a web server that hosts a web page accessible through network 260 by medical provider entity management systems 240. In some embodiments, medical provider entity analysis system 210 can include an application server configured to provide data to one or more client applications executing on computing systems connected to medical provider entity analysis system 210 via network 260.

In some embodiments, medical provider entity analysis system 210 can be configured to determine the actual revenue for a medical provider entity or specific medical provider entity location by processing and analyzing data collected from one or more components of system 200. For example, medical provider entity analysis system 210 can determine that the medical clinic located at 123 Main St, in Burbank, Calif., is actually generating $60,000 of revenue per month. Medical provider entity analysis system 210 can provide an analysis of a medical provider entity performance based on a target for revenue (or number of member entities) and the actual revenue for the medical provider entity. For example, for the medical clinic located at 123 Main St., Burbank, Calif., the medical provider entity analysis system 210 can provide an analysis that the clinic is performing above expectations. Exemplary processes that can be used by medical provider entity analysis system 210 are described below.

Medical provider entity analysis system 210 can, in some embodiments, generate and/or provide a user interface communicating data related to one or more medical provider entities. For example, in some embodiments, medical provider entity analysis system 210 includes a web server that generates HTML code, or scripts capable of generating HTML code, that can be displayed in a web browser executing on computing device. Medical provider entity analysis system 210 can also execute an application server that provides user interface objects to a client application executing on a computing device, or it can provide data that is capable of being displayed in a user interface in a client application executing on a computing device. In some embodiments, medical provider entity analysis system 210 can generate user interfaces that can be displayed within another user interface. For example, medical provider entity analysis system 210 can generate a user interface for display within a parent user interface that is part of a word processing application, a presentation development application, a web browser, or an illustration application, among others. Alternatively, generating a user interface can include generating the code that when executed displays information (e.g., HTML) on the user interface. In some embodiments, generating a user interface can include providing commands and/or data to a set of instructions that when executed render a user interface capable of being shown on a display connected to a computing device. Alternatively, the user interface can include a map, indications of the medical provider entity locations on a map, and indications of the sales or interactions associated with the medical provider entity locations. Examples of some (although not all) user interfaces that can be generated by medical provider entity analysis system 210 are described below.

Referring again to FIG. 2, medical services system 220 can be a computing system associated with a medical service provider, such as a hospital, a medical clinic, health insurance payer, pharmacy, or other entity that generates, provides, manages, and/or maintains medical accounts for one or more member entities. Medical services system 220 can generate, maintain, store, provide, and/or process medical claim data associated with one or more medical service accounts. Medical data can include, for example, medical account data, such as member entity's account identification data, claim amount, member entity's profile information, and medical interaction data, such as interaction dates, interaction amounts, interaction types, and location of interaction. In some embodiments, each interaction of medical data can include a plurality of categories of information associated with the interaction. For example, the plurality of categories of information can include at least one of: an interaction number category; a member entity identification category; a member entity location category; a medical provider entity identification category; a medical provider entity location category; a specialty of medical provider entity category; a medical procedure category; a medical diagnosis category; an interaction amount category; and a time of interaction category. It is appreciated that medical data can comprise either additional or fewer categories than the exemplary categories listed above. Medical services system 220 can include infrastructure and components that are configured to generate and/or provide medical accounts.

Geographic data systems 230 can include one or more computing devices configured to provide geographic data to other computing systems in system 200 such as medical provider entity analysis system 210. For example, geographic data systems 230 can provide geodetic coordinates when provided with a street address or vice-versa. In some embodiments, geographic data systems 230 exposes an application programming interface (API) including one or more methods or functions that can be called remotely over a network, such as network 260. According to some embodiments, geographic data systems 230 can provide information concerning routes between two geographic points. For example, medical provider entity analysis system 210 can provide two addresses and geographic data systems 230 can provide, in response, the aerial distance between the two addresses, the distance between the two addresses using roads, and/or a suggested route between the two addresses and the route's distance.

According to some embodiments, geographic data systems 230 can also provide map data to medical provider entity analysis system 210 and/or other components of system 200. The map data can include, for example, satellite or overhead images of a geographic region or a graphic representing a geographic region. The map data can also include points of interest, such as landmarks, malls, shopping centers, schools, or popular restaurants or retailers, for example.

Medical provider entity management systems 240 can be one or more computing devices configured to perform one or more operations consistent with disclosed embodiments. For example, medical provider entity management systems 240 can be a desktop computer, a laptop, a server, a mobile device (e.g., tablet, smart phone, etc.), or any other type of computing device configured to request medical provider entity analysis from medical provider entity analysis system 210. According to some embodiments, medical provider entity management systems 240 can comprise a network-enabled computing device operably connected to one or more other presentation devices, which can themselves constitute a computing system. For example, medical provider entity management systems 240 can be connected to a mobile device, telephone, laptop, tablet, or other computing device.

Medical provider entity management systems 240 can include one or more processors configured to execute software instructions stored in memory. Medical provider entity management systems 240 can include software or a set of programmable instructions that when executed by a processor performs known Internet-related communication and content presentation processes. For example, medical provider entity management systems 240 can execute software or a set of instructions that generates and displays interfaces and/or content on a presentation device included in, or connected to, medical provider entity management systems 240. In some embodiments, medical provider entity management systems 240 can be a mobile device that executes mobile device applications and/or mobile device communication software that allows medical provider entity management systems 240 to communicate with components of system 200 over network 260. The disclosed embodiments are not limited to any particular configuration of medical provider entity management systems 240.

Medical provider entity management systems 240 can be one or more computing systems associated with one or more medical provider entities providing medical products (e.g., pharmacies selling drugs) and/or medical services (e.g., hospital, private clinic, etc.). For ease of discussion, the exemplary embodiments presented herein relate to medical interactions involving healthcare consultations between a medical provider (e.g., a doctor) and a member entity (e.g., patient). Medical provider entity management systems 240, however, is not limited to systems associated with only doctors and can be applicable to other healthcare-related entities, such as pharmacies and healthcare-related equipment.

Member entity data systems 250 can include one or more computing devices configured to provide demographic data regarding member entities (e.g., patients seeking healthcare-related services from medical provider entities). For example, member entity data systems 250 can provide information regarding the name, address, gender, income level, age, email address, or other information about member entities. Member entity data systems 250 can include public computing systems such as computing systems affiliated with the National Plan and Provider Enumeration System, U.S. Bureau of the Census, the U.S. Bureau of Labor Statistics, or FedStats, or it can include private computing systems such as computing systems affiliated with health insurance payers, credit bureaus, social media sites, marketing services, or some other organization that collects and provides demographic data.

Network 260 can be any type of network or combination of networks configured to provide electronic communications between components of system 200. For example, network 260 can be any type of network (including infrastructure) that provides communications, exchanges information, and/or facilitates the exchange of information, such as the Internet, a Local Area Network, or other suitable connection(s) that enables the sending and receiving of information between the components of system 200. Network 260 may also comprise any combination of wired and wireless networks. In some embodiments, one or more components of system 200 can communicate directly through a dedicated communication link(s), such as links between medical provider entity analysis system 210, medical services systems 220, geographic data systems 230, medical provider entity management systems 240, and member entity data systems 250.

As noted above, medical provider entity analysis system 210 can include a data fusion system (e.g., data fusion system 100) for organizing data received from one or more of the components of system 200.

FIG. 3 is a block diagram of an exemplary computer system 300, consistent with embodiments of the present disclosure. The components of system 200 such as medical provider entity analysis system 210, medical service systems 220, geographic data systems 230, medical provider entity management systems 240, and member entity data systems 250 may include the components and/or architecture that is based on or similar to that of computer system 300.

As illustrated in FIG. 3, computer system 300 includes a bus 302 or other communication mechanism for communicating information, and one or more hardware processors 304 (denoted as processor 304 for purposes of simplicity) coupled with bus 302 for processing information. Hardware processor 304 can be, for example, one or more general-purpose microprocessors, becoming one or more special-purpose microprocessors during the collecting, processing, analyzing, and/or displaying information of the healthcare-related entities as described herein, or can be a reduced instruction set of one or more microprocessors.

Computer system 300 also includes a main memory 306, such as a random access memory (RAM) or other dynamic storage device, coupled to bus 302 for storing information and instructions to be executed by processor 304. Main memory 306 also can be used for storing temporary variables or other intermediate information during execution of instructions to be executed by processor 304. Such instructions, after being stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk, optical disk, hard drive, or USB thumb drive (Flash drive), etc. is provided and coupled to bus 302 for storing information and instructions.

Computer system 300 can be coupled via bus 302 to a display 312, such as a cathode ray tube (CRT), liquid crystal display, or touch screen, for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. The input device typically has two degrees of freedom in two axes, a first axis (for example, x) and a second axis (for example, y), that allows the device to specify positions in a plane. In some embodiments, the same direction information and command selections as cursor control can be implemented via receiving touches on a touch screen without a cursor.

Computing system 300 can include a user interface module to implement a graphical user interface that can be stored in a mass storage device as executable software codes that are executed by the one or more computing devices. This and other modules can include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the term “module,” as used herein, refers to logic embodied in hardware or firmware, or to a collection of software instructions, possibly having entry and exit points, written in a programming language, such as, for example, Java, Lua, C or C++. A software module can be compiled and linked into an executable program, installed in a dynamic link library, or written in an interpreted programming language such as, for example, BASIC, Perl, or Python. It is appreciated that software modules can be callable from other modules or from themselves, and/or can be invoked in response to detected events or interrupts. Software modules configured for execution on computing devices can be provided on a computer readable medium, such as a compact disc, digital video disc, flash drive, magnetic disc, or any other tangible medium, or as a digital download (and can be originally stored in a compressed or installable format that requires installation, decompression, or decryption prior to execution). Such software code can be stored, partially or fully, on a memory device of the executing computing device, for execution by the computing device. Software instructions can be embedded in firmware, such as an EPROM. It will be further appreciated that hardware modules can be comprised of connected logic units, such as gates and flip-flops, and/or can be comprised of programmable units, such as programmable gate arrays or processors. The modules or computing device functionality described herein are preferably implemented as software modules, but can be represented in hardware or firmware. Generally, the modules described herein refer to logical modules that can be combined with other modules or divided into sub-modules despite their physical organization or storage.

Computer system 300 can implement the techniques described herein using customized hard-wired logic, one or more ASICs or FPGAs, firmware and/or program logic which in combination with the computer system causes or programs computer system 300 to be a special-purpose machine. According to some embodiments, the operations, functionalities, and techniques and other features described herein are performed by computer system 300 in response to processor 304 executing one or more sequences of one or more instructions contained in main memory 306. Such instructions can be read into main memory 306 from another storage medium, such as storage device 310. Execution of the sequences of instructions contained in main memory 306 causes processor 304 to perform the process steps described herein. In alternative embodiments, hard-wired circuitry can be used in place of or in combination with software instructions.

The term “non-transitory media” as used herein refers to any non-transitory media storing data and/or instructions that cause a machine to operate in a specific fashion. Such non-transitory media can comprise non-volatile media and/or volatile media. Non-volatile media can include, for example, optical or magnetic disks, such as storage device 310. Volatile media can include dynamic memory, such as main memory 306. Common forms of non-transitory media can include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from, but can be used in conjunction with, transmission media. Transmission media can participate in transferring information between storage media. For example, transmission media can include coaxial cables, copper wire and fiber optics, including the wires that comprise bus 302. Transmission media can also take the form of acoustic or light waves, such as those generated during radio-wave and infra-red data communications.

Various forms of media can be involved in carrying one or more sequences of one or more instructions to processor 304 for execution. For example, the instructions can initially be carried on a magnetic disk or solid state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 can optionally be stored on storage device 310 either before or after execution by processor 304.

Computer system 300 can also include a communication interface 318 coupled to bus 302. Communication interface 318 can provide a two-way data communication coupling to a network link 320 that can be connected to a local network 322. For example, communication interface 318 can be an integrated services digital network (ISDN) card, cable modem, satellite modem, or a modem to provide a data communication connection to a corresponding type of telephone line. As another example, communication interface 318 can be a local area network (LAN) card to provide a data communication connection to a compatible LAN. Wireless links can also be implemented. In any such implementation, communication interface 318 can send and receives electrical, electromagnetic or optical signals that carry digital data streams representing various types of information.

Network link 320 can typically provide data communication through one or more networks to other data devices. For example, network link 320 can provide a connection through local network 322 to a host computer 324 or to data equipment operated by an Internet Service Provider (ISP) 326. ISP 326 in turn can provide data communication services through the world wide packet data communication network now commonly referred to as the “Internet” 328. Local network 322 and Internet 328 can both use electrical, electromagnetic or optical signals that carry digital data streams. The signals through the various networks and the signals on network link 320 and through communication interface 318, which carry the digital data to and from computer system 300, can be example forms of transmission media.

Computer system 300 can send messages and receive data, including program code, through the network(s), network link 320 and communication interface 318. In the Internet example, a server 330 can transmit a requested code for an application program through Internet 328, ISP 326, local network 322 and communication interface 318. The received code can be executed by processor 304 as it is received, and/or stored in storage device 310, or other non-volatile storage for later execution. In some embodiments, server 330 can provide information for being displayed on a display.

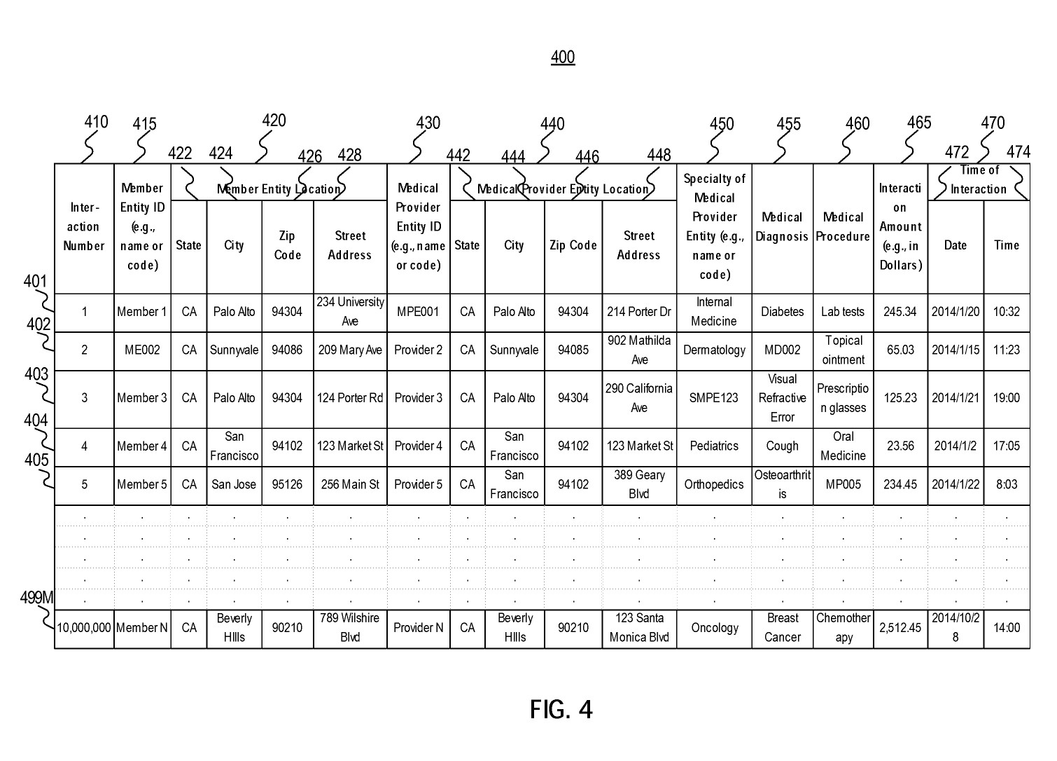

FIG. 4 is a block diagram of an exemplary data structure 400, consistent with embodiments of the present disclosure. Data structure 400 can store data records that include information associated with interactions involving multiple healthcare-related entities. Data structure 400 can be, for example, a database (e.g., database 170) that can store elements of an object model (e.g., object model 160). In some embodiments, data structure 400 can be a Relational Database Management System (RDBMS) that stores interaction data as sections of rows of data in relational tables. An RDBMS can be designed to efficiently return data for an entire row, or record, in as few operations as possible. An RDBMS can store data by serializing each row of data of data structure 400. For example, in an RDBMS, data associated with interaction 1 of FIG. 4 can be stored serially such that data associated with all categories of interaction 1 can be accessed in one operation.

Alternatively, data structure 400 can be a column-oriented database management system that stores data as sections of columns of data rather than rows of data. This column-oriented DBMS can have advantages, for example, for data warehouses, customer relationship management systems, and library card catalogs, and other ad hoc inquiry systems where aggregates are computed over large numbers of similar data items. A column-oriented DBMS can be more efficient than an RDBMS when an aggregate needs to be computed over many rows but only for a notably smaller subset of all columns of data, because reading that smaller subset of data can be faster than reading all data. A column-oriented DBMS can be designed to efficiently return data for an entire column, in as few operations as possible. A column-oriented DBMS can store data by serializing each column of data of data structure 400. For example, in a column-oriented DBMS, data associated with a category (e.g., member entity identification category 415) can be stored serially such that data associated with that category for all interactions of data structure 400 can be accessed in one operation.

As shown in FIG. 4, data structure 400 can comprise data associated with a very large number of interactions associated with multiple healthcare-related entities. For example, data structure 400 can include data associated with tens of millions medical claim data. In some embodiments, interactions associated with multiple healthcare-related entities can be referred to as transactions between multiple healthcare-related entities. Where appropriate, the terms interactions, transactions, claims, medical claims, healthcare-related claims, and pharmacy claims are intended to convey the same meaning and can be used interchangeably throughout this disclosure. While each interaction of data structure 400 is depicted as a separate row in FIG. 4, it is understood that each such interaction can be represented by a column or any other known technique in the art. Each interaction data can include several categories of information. For example, the categories can include, interaction number category 410; member entity identification category 415; member entity location category 420; medical provider entity identification category 430; medical provider entity location category 440; specialty of medical provider entity category 450; medical diagnosis category 455; medical procedure category 460; interaction amount category 465; and time of interaction category 470. It is understood that FIG. 4 is merely exemplary and that data structure 400 can include even more categories of information associated with an interaction.

Interaction number category 410 can uniquely identify each interaction of data structure 400. For example, data structure 400 depicts ten million healthcare-related interactions as illustrated by interaction number category 410 of the last row of data structure 400 as 10,000,000. In FIG. 4, each row depicting an interaction can be identified by an element number. For example, interaction number 1 can be identified by element 401; interaction number 2 can be identified by element 402; and so on such that interaction 10,000,000 can be identified by 499M. It is appreciated that this disclosure is not limited to any number of interactions and further that this disclosure can extend to a data structure with more or fewer than ten million interactions. It is also appreciated that interaction number category 410 need not exist in data structure 400.

Member entity identification category 415 can identify a member entity. In some embodiments, member entity identification category 415 can represent a name (e.g., Member 1 for interaction 401; Member N for interaction 499M) of the member entity. Alternatively, member entity identification category 415 can represent a code uniquely identifying the member entity (e.g., ME002 for interaction 402). For example, the identifiers under the member entity identification category 415 can be any identifier (e.g., social security number, tax identification number, etc) that can uniquely identify a person or a group of people.

Member entity location category 420 can represent a location information of the member entity. In some embodiments, member entity location category 420 can represent the location information by providing at least one of: a state of residence (e.g., state sub-category 422; California for element 401) of the member entity; a city of residence (e.g., city sub-category 424; Palo Alto for interaction 401) of the member entity; a zip code of residence (e.g., zip code sub-category 426; 94304 for interaction 401) of the member entity; and a street address of residence (e.g., street address sub-category 428; 234 University Ave., for interaction 401) of the member entity. In some embodiments, a separate database can provide member entity location category 420 with additional addresses and contact information of the member entity.

Medical provider entity identification category 430 can identify a medical provider entity (e.g., a hospital and a medical clinic). In some embodiments, medical provider entity identification category 430 can represent a name of the medical provider entity (e.g., Provider 2 for interaction 402). Alternatively, medical provider entity identification category 430 can represent a code uniquely identifying the medical provider entity (e.g., MPE001 for interaction 401). For example, medical provider entity identification category 430 can represent a National Provider Identifier as defined by the National Plan and Provider Enumeration System (NPPES). The Centers for Medicare & Medicaid Services, which is a part of U.S. Department of Health and Human Services has developed the NPPES to assign unique identifiers for healthcare providers and health plans. The purpose of NPPES and National Provider Identifier is to improve the efficiency and effectiveness of the electronic transmission of healthcare-related information. In some embodiments, the medical provider entity can be represented by more than one identifier under the medical provider entity identification category 430. For example, the medical provider entity identification category 430 can represent a license number of a doctor. When the doctor is licensed in multiple states, he will have multiple license numbers with each license number uniquely identifying the doctor.

Medical provider entity location category 440 can represent a location information of the medical provider entity. In some embodiments, medical provider entity location category 440 can represent the location information by providing at least one of: a state where the medical provider entity is located (e.g., state sub-category 442; California for interaction 401); a city where the medical provider entity is located (e.g., city sub-category 444; Palo Alto for interaction 401); a zip code where the medical provider entity is located (e.g., zip code sub-category 446; 94304 for interaction 401); and a street address where the medical provider entity is located (e.g., street address sub-category 448; 214 Porter Dr. for interaction 401). In some embodiments, a separate database can provide medical provider entity location category 440 with additional addresses and contact information of the medical provider entity.

Specialty of medical provider entity category 450 can identify a type of specialty of the medical provider entity involved in each interaction. In some embodiments, specialty of medical provider entity category 450 of the medical provider entity can be identified by a category name customarily used in the industry (e.g., internal medicine for interaction 401) or by an identification code that can identify a type of the medical provider entity (e.g., SMPE123 for interaction 403). Medical diagnosis category 455 can identify a type of medical diagnosis involved in each interaction. In some embodiments, medical diagnosis category 455 can be identified by a category name customarily used in the industry (e.g., diabetes for interaction 401) or by an identification code that can identify a medical diagnosis (e.g., MD002 for interaction 403). In some embodiments, a separate database can provide specialty of medical provider entity category 450 with practice details for the medical provider entity.

Medical procedure category 460 can identify a type of medical procedure associated with medical diagnosis 450 involved in each interaction. In some embodiments, medical procedure category 460 can be identified by a category name customarily used in the industry (e.g., prescription glasses for interaction 403) or by an identification code that can identify a medical procedure (e.g., MP005 for interaction 405). Interaction amount category 465 can represent a transaction amount (e.g., $245.34 for interaction 401) involved in each interaction. Time of interaction category 470 can represent a time at which the interaction was executed. In some embodiments, time of interaction category 470 can be represented by a date (e.g., date sub-category 472; Jan. 20, 2014, for interaction 401) and time of the day (e.g., time sub-category 474; 10:32 AM local time for interaction 401). Time sub-category 474 can be represented in either military time or some other format. Alternatively, time sub-category 474 can be represented with a local time zone of either medical provider entity location category 440 or member entity location category 420.

In some embodiments, each interaction can include categories of information including (not shown in FIG. 4), for example, member entity enrollment category, member entity age category, member entity gender category, member entity income category, and member entity with children category. Member entity enrollment category can represent the plan or line of business (LOB) in which the member entity is enrolled for a particular interaction. For example, member entity enrollment category can represent, for that particular interaction, that the member entity is enrolled in one of either a Medicare Advantage Preferred Provider Organization (PPO), a Commercial PPO, Medicaid, an exchanged-offered plan, or the like.

In some embodiments, member entity demographic information can be stored in each interaction. For example, member entity demographic information can include at least one of: member entity age category, member entity gender category, member entity income category, and member entity with children category. In some embodiments, member entity age category can represent age information associated with the member entity; member entity gender category can represent gender information (e.g., Male or Female) associated with the member entity; member entity income category can represent income information (e.g., greater than $100,000 per year) associated with the member entity; and member entity with children category can represent whether the member entity has any children under 18 or not. For example, if the member entity comprises children under 18, a positive indication can be stored and if the member entity does not comprise children under 18, a negative indication can be stored. In some embodiments, member entity with children category can store information representing a number of children associated with the member entity.

In some embodiments, database 170 can include data associated with pharmacy interactions and/or medical interactions. For example, data sets associated with pharmacy and medical interactions that include several categories of information can be depicted in tables below. It is appreciated that Tables 1-3 depict merely exemplary categories of information that can be associated with the various healthcare-related entities and are not meant to be limiting. It will also be understood that data categories depicted in Tables 1-3 can be alternative to or complementary to the data categories described in FIG. 4.

An exemplary data table associated with interactions is provided below in Table 1:

TABLE 1
Interaction data table

| Data Category | Description |
|---|---|
| Type | Type of interaction (e.g., 0 = Doctor; 1 = in-patient; |
| | 2 = out-patient) |
| Diagnosis 1 | Code associated with diagnosis 1 |
| Procedure 1 | Code associated with procedure 1 |
| Diagnosis 2 | Code associated with diagnosis 2 |
| Procedure 2 | Code associated with procedure 2 |
| First service date | Date of first service associated with the interaction |
| Adjudication date | Date of adjudication of the interaction |
| Net paid | Total amount paid for the interaction |
| Net billed | Total amount billed for the interaction |
| Contract | Contract code |
| Physician risk type | Physician risk type code |
| Facility risk type | Facility risk type code |
| Participating status | Participating status code |
| Place of service | Place of service code |
| Member | Identification of the member entity |
| Member's DOB | Date of birth of the member entity |
| Member's gender | Gender of the member entity (e.g., 0 = female; 1 = |
| | male) |
| Member's zip code | Zip code of the member entity |
| Provider | Identification of the medical provider entity |
| Provider's zip code | Zip code of the medical provider entity |
| Provider's specialty | Specialty of the medical provider entity |
| Referring provider | Identification of the referring provider entity |
| PCP Provider | Identification of the primary care physician provider |
| | entity |

Another exemplary data table associated with member entities is provided below in Table 2:

TABLE 2
Member data table

| Data Category | Description |
|---|---|
| ID | Identification of the member entity |
| SSN | Social security number of the member entity |
| Birth date | Date of birth of the member entity |
| Gender | Gender of the member entity |
| Zip code | Zip code of the member entity |
| Ethnicity | Ethnicity of the member entity |
| Education level | Education level of the member entity |
| Language | Language of the member entity |
| Income range | Code representing income range of the member entity |
| Height | Height of the member entity |
| Weight | Weight of the member entity |
| Occupation Type | Code representing occupation of the member entity |

Another exemplary data table associated with medical provider entities is provided below in Table 3:

TABLE 3
Medical provider entity data table

| Data Category | Description |
|---|---|
| ID | Identification of the medical provider entity |
| Name | Name of the medical provider entity |
| NPI | National Provider Identifier of the medical provider |
| | entity |
| TIN | Tax identification number of the medical provider entity |
| Address | First line of address of the medical provider entity |
| City | Name of the city of the medical provider entity |
| Zip code | Zip code of the medical provider entity |
| Specialty | Specialty of the medical provider entity |

In some embodiments, an objective for analyzing healthcare-related data is to provide a generalizable platform for analyzing performance of various entities involved in healthcare industry including, medical provider entities, member entities, healthcare insurance provider entities, etc.

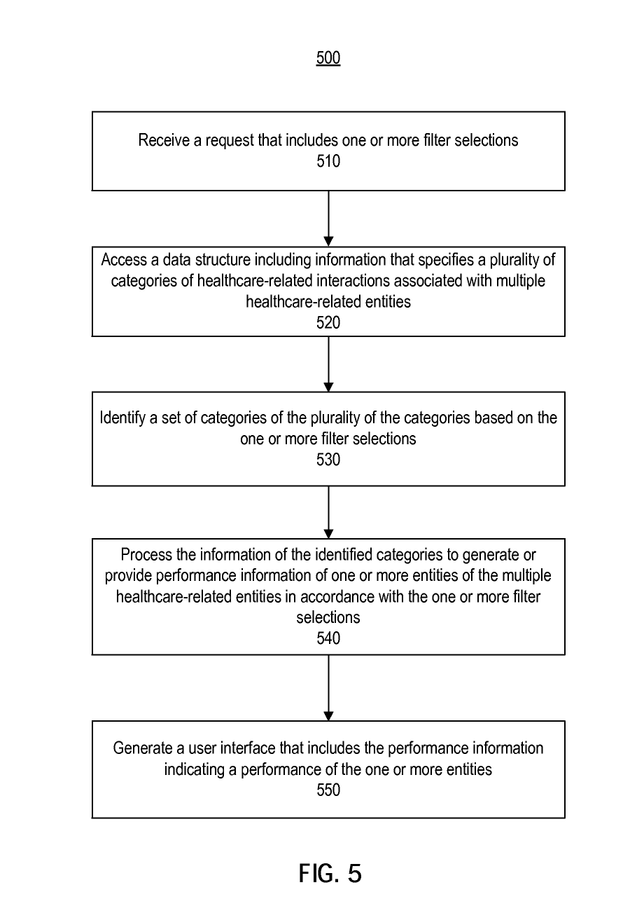

FIG. 5 depicts a flowchart representing an exemplary process for analyzing entity performance, consistent with embodiments of the present disclosure. While the flowchart discloses the following steps in a particular order, it is appreciated that at least some of the steps can be moved, modified, or deleted where appropriate, consistent with the teachings of the present disclosure. While the following steps are performed by a medical provider entity analysis system (e.g., medical provider entity analysis system 210), it is appreciated that some of these steps can be performed in full or in part by other systems (e.g., such as those systems identified above in FIG. 2).

In step 510, the medical provider entity analysis system can receive a request that includes one or more filter selections for analyzing a performance of one or more entities of multiple healthcare-related entities. In some embodiments, the request can be received from a medical provider entity (e.g., a hospital), which can be interested in analyzing its performance with regards to the one or more filter selections. In some embodiments, one or more filter selections of the received request can comprise a selection to represent data associated with at least one of: members; providers; claims; procedures; diagnoses; and time. Alternatively, the one or more filter selections can comprise a selection to represent data associated with at least one of: charts; histograms; maps; numbers; and time.

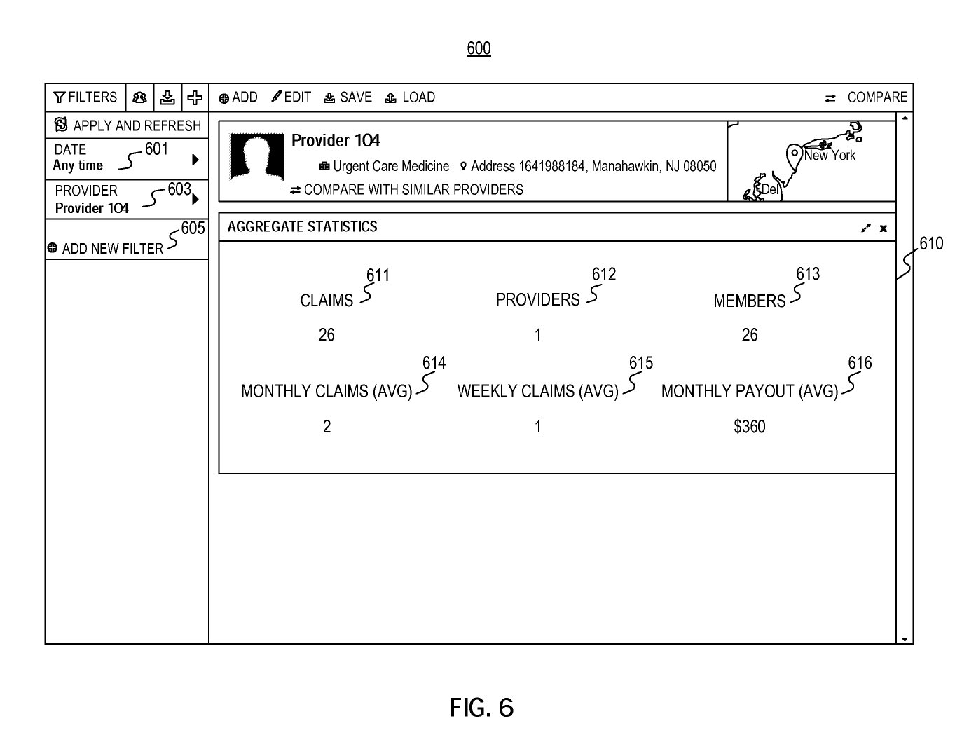

In some embodiments, the one or more filter selections can comprise a selection to represent data associated with at least one of: demographic information representing at least one of age, gender, income, social security number, and location associated with the member entity; information representing the medical provider entity's location; information representing the medical provider entity's identification; information representing the medical provider entity's specialty; information representing an amount associated with an interaction; information representing a medical diagnosis associated with an interaction; information representing a medical procedure associated with an interaction; and a time associated with an interaction. An exemplary block diagram of a user interface with exemplary filter selections is shown in FIGS. 6-14, described below.

In some embodiments, the process of analyzing a performance of one or more entities of multiple healthcare-related entities can be implemented without having to receive one or more filter selections. Such a process can be implemented, for example, by having the medical provider entity analysis system (comprise one or more predetermined filter selections. These exemplary one or more predetermined filter selections can include the same selections as the one or more filters (e.g., add new filter 605 shown in FIG. 6) that can be selected by a user as described above. For example, the one or more predetermined filter selections can comprise at least one of: members; providers; claims; procedures; diagnoses; and time. Alternatively, the one or more filter selections can comprise a selection to represent data associated with at least one of: charts; histograms; maps; numbers; and time.

In step 520, the medical provider entity analysis system can access a data structure (e.g., data structure 400) including information that specifies a plurality of categories of healthcare-related interactions associated with multiple healthcare-related entities. The data structure can represent information associated with a very large number of interactions. In some embodiments, the data structure can represent information for tens of millions of healthcare-related interactions (e.g., data structure 400 depicting 10 million healthcare-related interactions). The data structure can be similar to the exemplary data structure 400 described in FIG. 4 and/or the examples of Tables 1-3 above. In exemplary embodiments comprising one or more predetermined filter selections, accessing step 520 can be implemented in the same fashion as that of the exemplary embodiments where one or more filter selections can be received from a user.

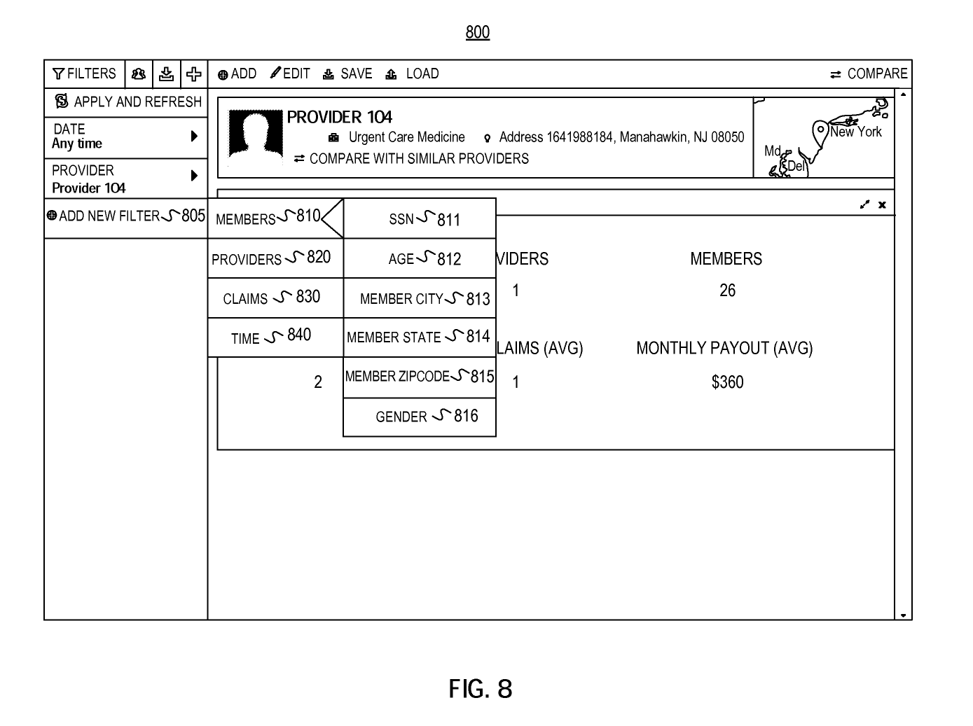

In step 530, the medical provider entity analysis system can identify a set of categories from the plurality of categories within the data structure based on the received filter selections. The set of identified categories, for example, can be one or more of the plurality of categories of the data structure (e.g., data structure 400). In some embodiments, there can be a mapping between the one or more filter selections and the plurality of categories. For example, a filter selection for member entity zip code can be mapped to member entity location category 420 and further to zip code sub-category 426. Another exemplary mapping can exist between a filter selection for gender (e.g., gender 816 in FIG. 8) and a category or a sub-category associated with a gender of member entity (not shown in FIG. 4). It is appreciated that the mapping techniques described above are merely exemplary and other mapping techniques can be defined within the scope of this disclosure. When the medical provider entity (e.g., a medical clinic) is interested in analyzing its performance at a particular location with respect to member entities (e.g., a patient visiting the medical clinic) that use medical services of the medical provider entity, as shown in FIG. 8, the medical provider entity can select one or more filters such as members 810 and further member zipcode 815 (associated with a zip code representing location of member entity).

Based on the one or more filter selections, the medical provider entity analysis system (e.g., medical provider entity analysis system 210) can identify some categories of the data structure that are relevant for analyzing the performance of the one or more entities (e.g., medical provider entity) regarding member entity demographics including a location (e.g., zip code) of the member entities. In an example where the received filter selection include members 810 and further member zipcode 815, the medical provider entity analysis system can identify categories associated with a number of interaction (e.g., number category 410 as shown in FIG. 4), an identity of member entities (e.g., member entity identification category 415), and a location of member entities (e.g., member entity location category 420 including at least zip code sub-category 426). In some embodiments, member entity location category 420 can be identified along with one or more categories of state sub-category 422, city sub-category 424, zip code sub-category 426, and street address sub-category 428. In exemplary embodiments comprising one or more predetermined filter selections, identifying step 530 of FIG. 5 can be implemented in the same fashion as that of the exemplary embodiments where one or more filter selections can be received from a user.

At step 540, the medical provider entity analysis system can process information associated with the identified categories to generate or provide performance information of one or more entities of the multiple healthcare-related entities in accordance with the one or more filter selections. In some embodiments, a first entity of the one or more entities can be a medical provider entity. One or more entities of the multiple healthcare-related entities can comprise one or more groups of entities of the multiple healthcare-related entities. For example, a group of entities can be defined such that the group of entities has similar characteristics, such as all dentist clinics within a given zip code or all pharmacy store locations (e.g., Walgreens™) within a city (e.g., San Jose, Calif.). Processing the identified categories can comprise creating a new data structure that is different from the data structure of step 520. In some embodiments, the new data structure may comprise only the identified categories of step 530 or one or more subsets of those categories. Alternatively, processing the identified categories can be performed on the existing data structure of step 520 (e.g., data structure 400).

By way of example, when the one or more filter selections includes “member zip code,” the system can process information that is associated with identified categories based on the filter selections such as a number of interaction (e.g., number category 410), an identity of member entities (e.g., member entity identification category 415), a location of member entities (e.g., member entity location category 420 including at least zip code sub-category 426), and categories associated with member entity demographics including member entity age category, member entity gender category, and member entity income category. In some embodiments, data associated with identified categories can be stored in either a row-oriented database or a column-oriented database, as described above with respect to data structure 400. Processing information can involve performing statistical analysis on data stored in the identified categories. Performing statistical analysis, for example, can include various computations of data associated with identified categories. For example, if an identified category is interaction amount category 460, processing information can include performing an aggregate of the interaction amount to compute a total amount for all interactions associated with the medical provider entity. It is understood that processing information can include other examples of performing statistical analysis, including but not limited to, computing an average, mean, maximum, minimum, or standard deviation for a series of data.

In some embodiments, processing the information of the identified categories can result in a multitude of useful insights regarding the behavior of member entities or the performance of the medical provider entities. An exemplary insight can be to provide a summary of the entity's performance. Such an insight, for example, can be represented in a dashboard illustrating a medical providing entity's performance. For example, FIG. 6 includes a dashboard 610 that depicts a performance of medical provider entity, provider 104, which includes number of claims (e.g., claims 611), a number of medical provider entities (e.g., providers 612), a number of member entities (e.g., members 613), average number of claims in a month (e.g., monthly claims (AVG) 614), average number of weekly claims (e.g., weekly claims (AVG) 615), and average payout on a monthly basis (e.g., monthly payout (AVG) 616). Provider 104, as depicted in FIG. 6 can be an urgent care medical facility in Manahawkin, N.J. Dashboard 610 can depict information related to a number of claims associated with provider 104 for one or more filter selections. Alternatively, dashboard 610 can represent information related to claims associated with provider 104 without receiving any filter selections. For example, as depicted in FIG. 6, claims 611 depicts that total claims associated with provider 104 without receiving any filter selections. That is, claims 611 can represent that the total number of claims associated with provider 104 in its lifetime is 26.

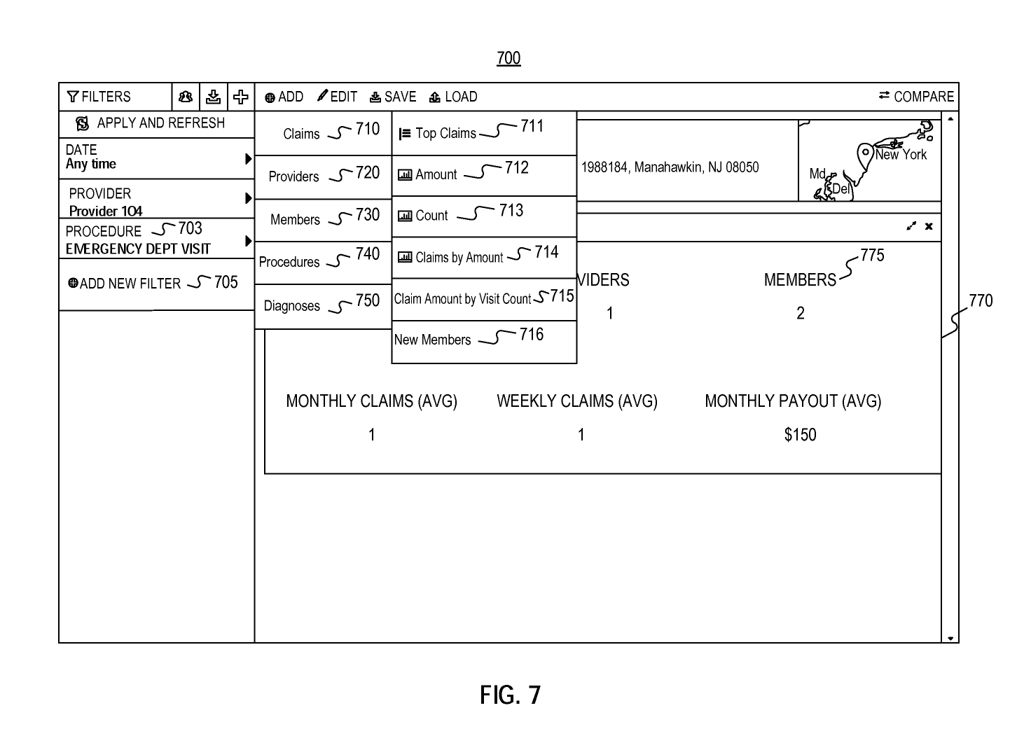

In some embodiments, dashboard 610 can represent information related to claims, member entities, or providing entities associated with one or more filter selections. For example, FIG. 7 shows filter selections that can be related to interactions (e.g., claims 710), medical provider entities (e.g., providers 720), member entities (e.g., members 730), medical procedures (e.g., procedures 740), and medical diagnoses (diagnoses 750). FIG. 7 also shows sub-filter selections that can be associated with each filter selection. For example, FIG. 7 depicts sub-filter selections associated with interactions filter selection (e.g., claims 710) that can include a selection associated with top claims (e.g., top claims 711), claim amount (e.g., amount 712), statistics based on claim count (e.g., count 713), statistics based on claim amount (e.g., claims by amount 714), statistics based on claim amount and claim count (e.g., claim amount by visit count 715), and first-time member entities (e.g., new members 716). It is understood that the above-mentioned filter selections and sub-selections are not limiting and there can other filter selections and sub-selections within the scope of this disclosure.

Some of useful insights, for example, can relate to the kinds of services (e.g., doctor visit) availed or products bought (e.g., prescription drugs or medical equipment) by member entities, a location where member entities avail the services or buy the products, a time as to when member entities avail the services or buy the products, the frequency with which member entities avail the services or buy the products, a location of residence of member entities, demographics information of member entities including their age and income level.

In some embodiments, processing the information of the identified categories can result in a multitude of additional useful insights regarding the performance of medical provider entities. For example, such additional insights can relate to an ability to detect any irregularities such as fraud associated with medical claims and/or prescription claims; an ability by a provider to be able to analyze and compare its performance with other providers in a given region; an ability to perform a cohort analysis, where a cohort can be a group of entities that share an attribute. Other forms of insights can include providing a summary of the kinds of medical services being offered by medical provider entities; a performance comparison between different locations of the same medical provider entity; etc. It is understood that the above-listed insights are merely exemplary and a number of other insights can be drawn within the scope and spirit of this disclosure.

In some embodiments, the medical provider entity analysis system can process (in step 540) information of a data structure that is updated in real-time. That is, processing of information can occur on the data structure that comprises up-to-date interaction data at the time of an execution of step 540. Alternatively, the medical provider entity analysis system can process information of a data structure that is not updated in real-time. That is, processing of information can occur on the data structure that does not comprise up-to-date interaction data at the time of an execution of step 540. For example, processing of information can occur on a data structure that is updated only periodically (e.g., on a daily or weekly basis) and not in real-time. In exemplary embodiments comprising one or more predetermined filter selections, the medical provider entity analysis system can process information (step 540) in the same fashion as that of the exemplary embodiments where one or more filter selections can be received from a user.

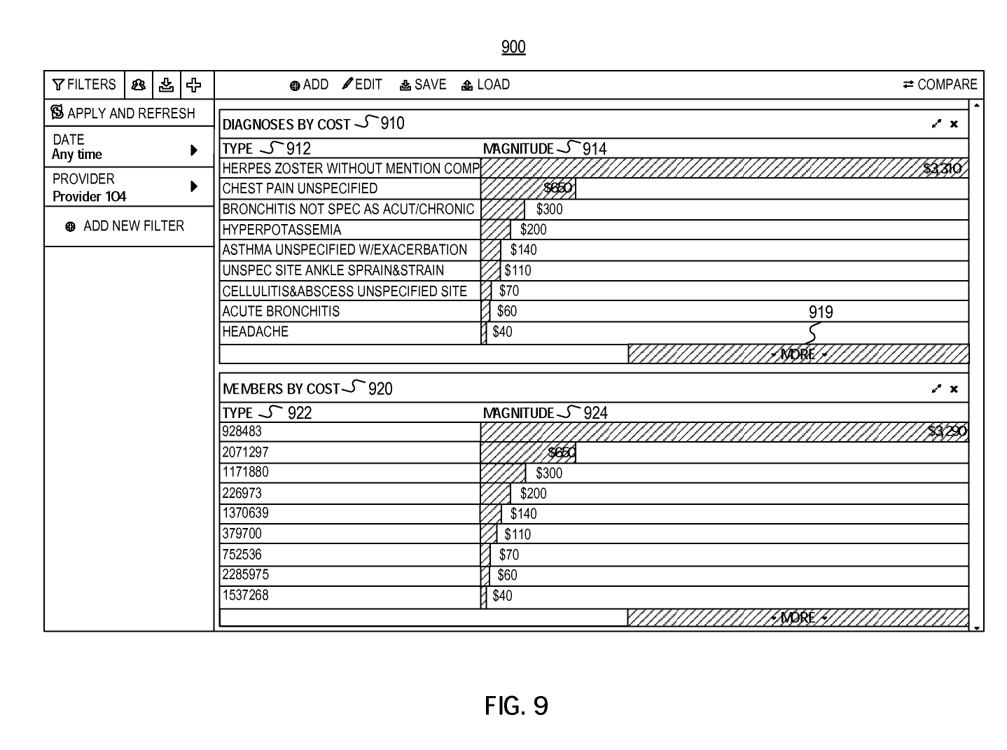

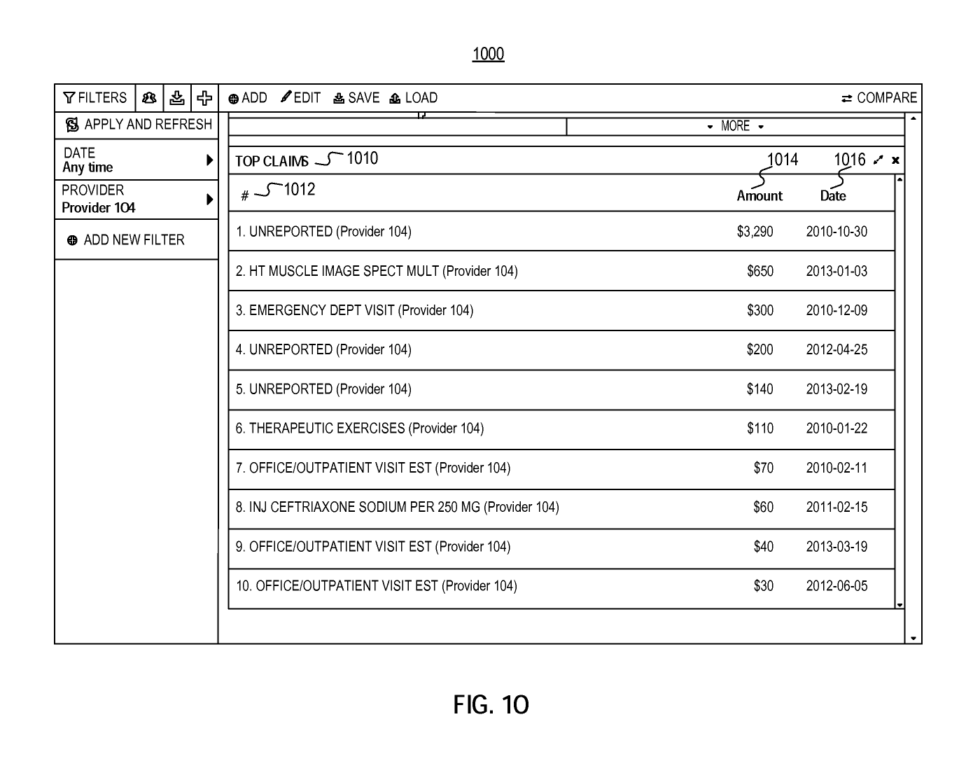

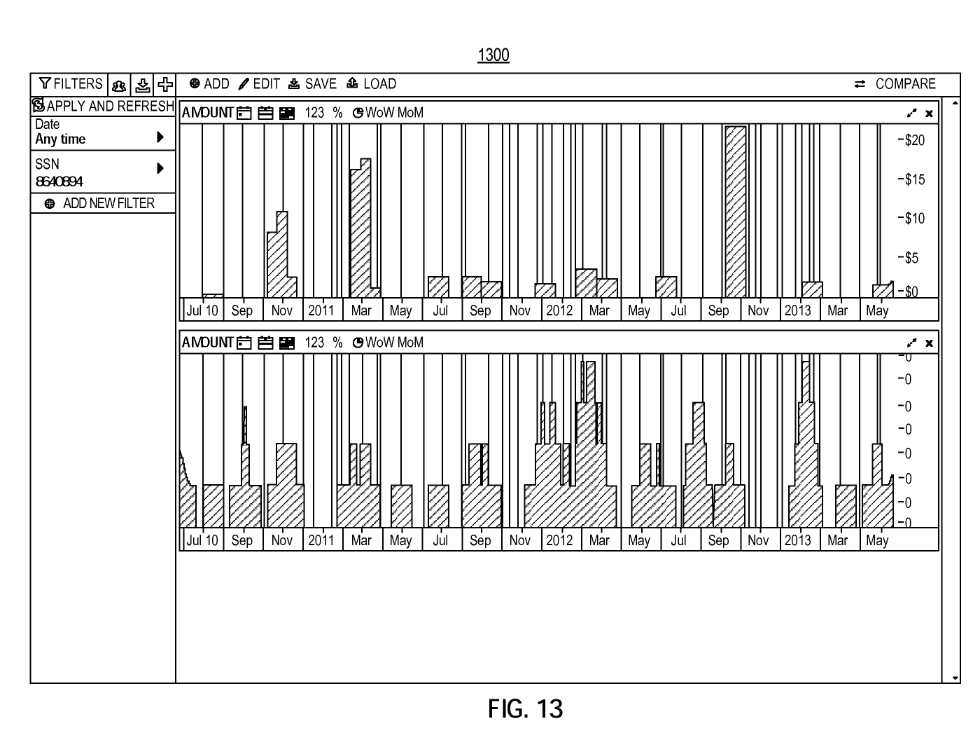

In step 550, the medical provider entity analysis system can generate a user interface that includes the performance information indicating the performance of the one or more entities (e.g., medical provider entity). In some embodiments, the user interface can comprise a representation of a geographic region. The user interface can also comprise a representation of locations of the one or more entities overlaid on the geographic region; and further a representation of sub-geographic regions overlaid on a geographic region. Alternatively, the user interface can include a representation of the performance of the one or more entities over geographic or sub-geographic regions associated with a location of the one or more entities. For example, geographic or sub-geographic regions can be associated with a location of either a member entity or a medical provider entity. In some embodiments, the user interface can include a representation of the performance as a dashboard (e.g., dashboard 610 of FIG. 6), a bar graph chart (e.g., diagnoses by cost 910 and members by cost 920 of FIG. 9), a tabular chart (e.g., top claims 1010 of FIG. 10), histograms (not shown in figures), a pie chart (not shown in figures), or other graphical representations (e.g., charts 1310 and 1320 of FIG. 13). It is understood that the above-listed representations of the user interface are merely exemplary and a number of other forms of statistical representations can be shown in the user interface within the scope and spirit of this disclosure.

In exemplary embodiments comprising one or more predetermined filter selections, the medical provider entity analysis system can provide the processed information (step 550) in the same fashion as that of the exemplary embodiments where one or more filter selections can be received from a user. Exemplary user interfaces are depicted in FIGS. 6-14 that illustrate a performance of a medical provider entity and/or a member entity based on one or more filter selections. As shown in FIGS. 6-14, user interface can provide a graph-based, map-based, text-based information or any other related form of information.

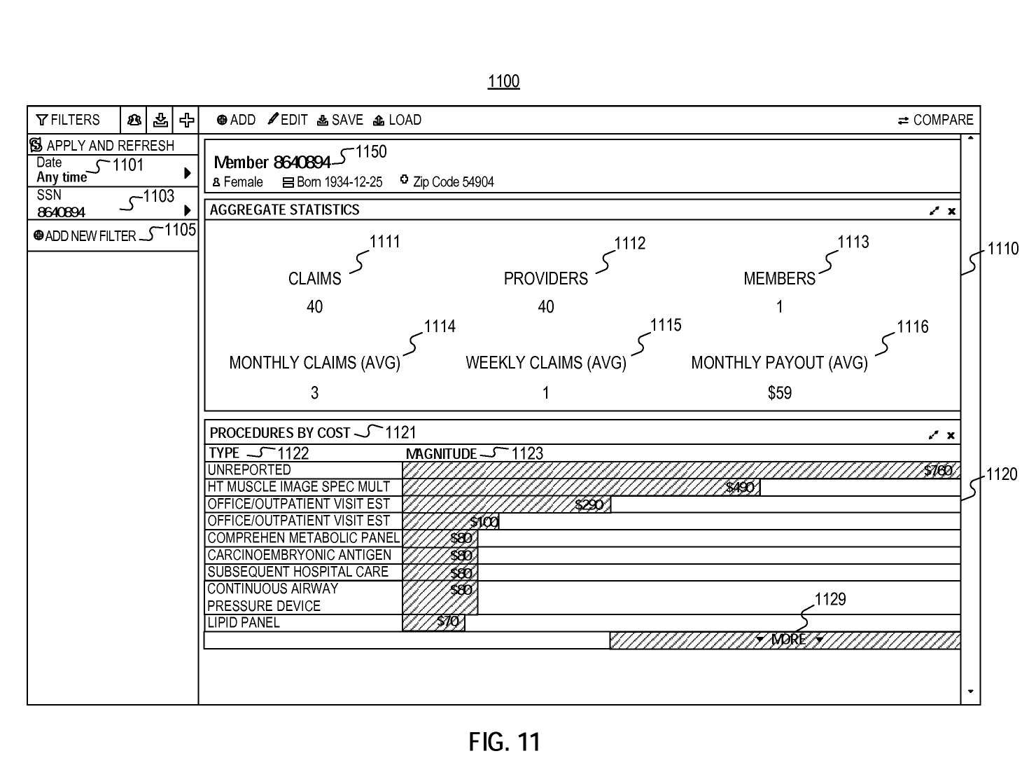

FIGS. 6-14 illustrate several exemplary user interfaces that can be generated by medical provider entity analysis system, consistent with embodiments of the present disclosure. The exemplary user interfaces of FIGS. 6-14 are meant to help illustrate and describe certain features of disclosed embodiments, and are not meant to limit the scope of the user interfaces that can be generated or provided by the medical provider entity analysis system. FIGS. 6-10 illustrate a performance metric of a medical provider entity whereas FIGS. 11-14 illustrate a performance metric of a member entity.

FIG. 6 shows an exemplary user interface 600 generated by a medical provider entity analysis system (e.g., medical provider entity analysis system 210), according to some embodiments. A user can initially select either one or more entities to analyze a performance metric associated with the selected one or more entities. In some embodiments, the one or more selected entities can be member entities. Alternatively, the selected one or more entities can be medical provider entities. For example, FIG. 6 depicts a performance metric associated with a medical provider entity, provider 104. User interface 600 includes an option to add one or more filter selections (e.g., add new filter 605). In some embodiments, a medical provider entity (or a user of a medical provider entity) can select the option to select the one or more filter selections. Alternatively, a member entity can select the option to select the one or more filter selections. User interface 600 can depict information related to performance associated with one or more entities. For example, user interface 600 can depict information related to performance associated with either a member entity or a medical provider entity.

FIG. 6 shows information related to a performance associated with medical provider entity, provider 104, an urgent care medical facility in Manahawkin, N.J. User interface 600 can include a user interface element to display a time period (e.g., date 601) associated with a performance metric depicted in FIG. 6. User interface 600 can also include user interface element to display an identity of an entity (e.g., provider 603) whose performance can be analyzed and can be depicted. In some embodiments, user interface elements date 601 and provider 603 can be displayed in response to received filter selections. User interface 600 can include a dashboard representing a performance summary of an entity. For example, dashboard 610 can represent a performance summary of medical provider entity, provider 104, that includes number of claims (e.g., claims 611), a number of medical provider entities (e.g., providers 612), a number of member entities (e.g., members 613), average number of claims in a month (e.g., monthly claims (AVG) 614), average number of weekly claims (e.g., weekly claims (AVG) 615), and average payout on a monthly basis (e.g., monthly payout (AVG) 616).

Claims 611 can represent a number of claims associated with provider 104 either over its lifetime or for a particular period of time. In some embodiments, claims 611 can represent a number of claims associated with interactions based on received filter selections. Providers 612 can represent a number of medical provider entities associated with interactions of provider 104. In this particular example, because provider 104 is the only medical provider entity selected, providers 612 represents a value 1. Alternatively, if two or more medical provider entities are selected to be depicted on user interface 600, providers 612 can have a value greater than 1. Members 613 can represent a number of member entities associated with interactions of provider 104. In this particular example, members 613 represents a value 26 signifying that each of the 26 claims associated with provider 104 is further associated with a unique member entity. Alternatively, if any member entity associated with provider 104 is involved in more than one interaction with provider 104, members 613 can have a value less than a number represented by claims 611 (e.g., less than 26 for claims 611).

Monthly claims (AVG) 614 can represent an average number of claims associated with provider 104 per month either over its lifetime or for a particular period of time. In some embodiments, monthly claims (AVG) 614 can represent an average number of claims associated with received filter selections. Weekly claims (AVG) 615 can represent an average number of claims associated with provider 104 per week either over its lifetime or for a particular period of time. In some embodiments, weekly claims (AVG) 615 can represent an average number of claims associated with received filter selections. Monthly payout (AVG) 616 can represent an average claim amount that provider 104 is able to get reimbursed for the services they perform per month either over its lifetime or for a particular period of time. It is understood that the above-described user interface elements are not limiting and there can be other user interface elements within the scope of this disclosure.

FIG. 7 shows an exemplary user interface 700 generated by a medical provider entity analysis system (e.g., medical provider entity analysis system 210), according to some embodiments. User interface 700 includes an option to add one or more filters (e.g., add new filter 705). In some embodiments, the option to add one or more filters can include adding filters related to filter selections and sub-selections as described in step 540 above.

User interface 700 can represent a dashboard (e.g., dashboard 770) that depicts a performance metric for an entity selected (e.g., provider 104 of FIG. 7). In some embodiments, after a user enters filter selections (e.g., add new filter 705), the medical provider entity analysis system receives a message to regenerate or modify the user interface. For example, if a user selects procedures 740 and then emergency dept visit into add new filter 705 box, the medical provider entity analysis system could receive a message indicating that a user interface should display dashboard 770 with a summary of interaction statistics associated with provider 104. The system can identify interactions associated with the received filter selection of emergency department visit 703 and further process those interactions to evaluate a performance metric of the provider 104. After evaluation, the performance metric can be depicted as dashboard 770. For example, members 775 of dashboard 770 represents number 2 as the number of member entities that are associated with interactions involving emergency department visits 703 for provider 104. In comparison, members 613 of dashboard 610 represents number 26 as the number of member entities that are associated with all kinds of medical procedure for the same provider, provider 104. It is understood that user interface 700 can further comprise representations associated with other filter (and sub-filter) selections, including but not limited to, claims 710, providers 720, members 730, and diagnoses 750.

User interface 700 can include a map (not shown in FIG. 7), which can show location information of member entities and geohash region (while shown as shaded rectangles, they can also include any unshaded rectangles) associated with such location information. A geohash region, or geohash bucket, is a region associated with a latitude/longitude, hierarchal geocode system that subdivides regions of the Earth into grid shaped buckets. The level of granularity of geohash regions can vary depending on the length of the geohash code corresponding to that region. For example, a geohash code that is one bit in length can correspond to a geohash region of roughly 20 million square kilometers, and a geohash code that is six bits in length can correspond to a geohash region of roughly 1.2 square kilometers. In some embodiments, a geohash region of five bits (roughly 18 square kilometers) is preferred, although the size of the geohash region can depend on the character of the overall region which is being geohashed. For example, a six bit geohash can be more suitable for a densely populated urban area, while a four bit geohash can be more suitable for a sparsely populated rural area. In some embodiments, location information of an entity can be represented by a geohash region. For example, a geohash region of five bits representing San Jose, Calif., can comprise the latitude/longitude coordinates, N 37.3394° W 121.8950°. Alternatively, location information can be represented using a zip code. For example, a portion of San Jose, Calif., can be represented by using a zip code, 95113. It is appreciated that location information can be represented in other ways such as street address, city, state, Global Positioning Satellite coordinates, etc.

FIG. 8 shows an exemplary user interface 800 generated by a medical provider entity analysis system (e.g., medical provider entity analysis system 210), according to some embodiments. User interface 800 includes an option to add one or more filters (e.g., add new filter 805). In some embodiments, the option to add one or more filters can include, similar to FIG. 7, adding filters related to interactions associated with member entities (e.g., members 810), medical provider entities (e.g., providers 820), medical claims (e.g., claims 830), and a time of the occurrence of the interactions (e.g., time 840).

User interface 800 can also depict sub-filter selections that can be associated with a filter selection. For example, user interface 800 can depict sub-filter selections associated with member entities (e.g., members 810) that can include a selection associated with member entity's identification (e.g., SSN 811 that can represent a social security number), member entity's age (e.g., age 812), member entity's city (e.g., member city 813), member entity's state (e.g., member state 814), member entity's zip code (e.g., member zipcode 815), and member entity's gender (e.g., gender 816). It is understood that sub-filter selections associated with other filter selections (e.g., providers 820, claims 830, and time 840) can be included within user interface 800 such that each such filter selection can have sub-filter selections similar to that of filter selection members 810. For example, providers 820 can include sub-filter selections (not shown in FIG. 8) comprising entity identification and entity location.

FIG. 9 shows an exemplary user interface 900 generated by a medical provider entity analysis system (e.g., medical provider entity analysis system 210), according to some embodiments. User interface 900 includes a bar chart or bar graph depicting a performance metric of an entity (e.g., provider 104) for exemplary filter selections (e.g., diagnoses by cost 910 and members by cost 920). Diagnoses by cost 910 represents a bar graph of interactions associated with provider 104 such that the diagnoses are depicted in a bar graph in a decreasing order of cost associated with the diagnosis. Diagnoses by cost 910 can include a column representing a type of diagnosis involved (e.g., type 912) and a bar graph portion representing a cost associated with the diagnoses using bars (e.g., magnitude 914) such that the higher the cost of a diagnosis, the longer the bar associated with the diagnosis. For example, type 912 represents “Herpes Zoster Without Mention Comp” as the diagnosis with the highest cost and is depicted as the longest bar in the bar graph.

User interface 900 also includes another bar graph depicting members by cost 920 that represents a bar graph of interactions associated with provider 104 such that member entities are depicted in a bar graph in a decreasing order of cost associated with the member entity. Members by cost 920, similar to diagnoses by cost 910, can include a column representing an identity of member entity involved (e.g., type 922) and a bar graph portion representing a cost associated with the member entity using bars (e.g., magnitude 924) such that the higher the cost associated with a member entity, the longer the bar associated with the member entity. For example, type 922 represents “928483” as the member entity with the highest cost and is depicted as the longest bar in the bar graph. While bar graphs of FIG. 9 are depicted as horizontal bar graphs, it is understood that a vertical bar graph, a histogram, or any other type of statistical analysis depiction can be used to represent the information showing a performance metric of a healthcare-related entity. It will also be understood that user interface 900 can include user-friendly features such that a user can, for example, click on magnitude 914 (or magnitude 922) to toggle between a descending order and an ascending order for the representation. Furthermore, while user interface 900 depicts only the top nine representations on the bar graph (diagnoses or member entities), a user can select an option (e.g., more 919) to increase or decrease the number of depicted representations on the bar graph.

FIG. 10 shows an exemplary user interface 1000 generated by a medical provider entity analysis system (e.g., medical provider entity analysis system 210), according to some embodiments. User interface 1000 includes a table depicting a performance metric of an entity (e.g., provider 104) for exemplary filter selections (e.g., top claims 1010). The table can represent the interactions associated with provider 104 and have the highest claim amount involved. For example, top claims table 1010 includes a column showing the top ten interactions with the highest claim amount that ranges from $3290 as the highest claim to $30 as the tenth highest claim. Top claims table 1010 also includes a column showing a number of the claim (e.g., #1012), a column showing a claim amount (e.g., amount 1014), and a column showing a date of occurrence for the claim (e.g., date 1016).

FIG. 11 shows an exemplary user interface 1100 generated by a medical provider entity analysis system (e.g., medical provider entity analysis system 210), according to some embodiments. FIG. 11 depicts a performance metric associated with a member entity, member 8640894. FIG. 11, while depicting a performance metric for a member entity, can include similar features as that of FIG. 6 that depicts a performance metric for a medical provider entity. User interface 1100 includes an option to add one or more filter selections (e.g., add new filter 1105). User interface 1100 can depict information related to performance associated with one or more entities. As depicted by element number 1150, user interface 1100 can depict some of the member entity's information (e.g., element 1150 shows member entity's sex, date of birth, and location information). User interface 1100 can include a user interface element to display a time period (e.g., date 1101) associated with a performance metric depicted in FIG. 11. User interface 1100 can also include user interface element to display an identity of a member entity (e.g., SSN 1103) whose performance can be analyzed and can be depicted. In some embodiments, user interface elements date 1101 and SSN 1103 can be displayed in response to received filter selections.

User interface 1100 can include a dashboard representing a performance summary of an entity. For example, dashboard 1110 can represent a performance summary of member entity, member 8640894, that includes number of claims (e.g., claims 1111), a number of medical provider entities (e.g., providers 1112), a number of member entities (e.g., members 1113), average number of claims in a month (e.g., monthly claims (AVG) 1114), average number of weekly claims (e.g., weekly claims (AVG) 1115), and average payout on a monthly basis (e.g., monthly payout (AVG) 1116).

The various user interface elements of dashboard 1100 can be similar to the elements of dashboard 610 of FIG. 6. Claims 1111 can represent a number of claims associated with member 8640894 either over the member's lifetime or for a particular period of time. In some embodiments, claims 1111 can represent a number of claims associated with received filter selections. Providers 1112 can represent a number of medical provider entities associated with interactions of member 8640894. In this particular example, providers 1112 represents a value 40 signifying that each of the 40 claims associated with member 8640894 is further associated with a unique medical provider entity. Alternatively, if any medical provider entity associated with member 8640894 is involved in more than one interaction with member 8640894, providers 1112 can have a value less than a number represented by claims 1111 (e.g., less than 40 for claims 1111). Members 1113 can represent a number of member entities associated with interactions of member 8640894. In this particular example, because Member 8640894 is the only member entity selected, members 1113 represents a value 1. Alternatively, if two or more member entities are selected to be depicted on user interface 1100, members 1113 can have a value greater than 1.

Monthly claims (AVG) 1114 can represent an average number of claims associated with member 8640894 per month either over the member's lifetime or for a particular period of time. In some embodiments, monthly claims (AVG) 1114 can represent an average number of claims associated with received filter selections. Weekly claims (AVG) 1115 can represent an average number of claims associated with member 8640894 per week either over the member's lifetime or for a particular period of time. In some embodiments, weekly claims (AVG) 1115 can represent an average number of claims associated with received filter selections. Monthly payout (AVG) 1116 can represent an average claim amount that was involved in each interaction of member 8640894 per month either over the member's lifetime or for a particular period of time. It is understood that the above-described user interface elements are not limiting and there can other user interface elements within the scope of this disclosure.

User interface 1100 also includes a bar chart or bar graph depicting a performance metric of member 8640894 for exemplary filter selections (e.g., procedures by cost 1121). Procedures by cost 1121 represents a bar graph of interactions associated with member 8640894 such that the procedures are depicted in a bar graph in a decreasing order of cost associated with the procedure. Procedures by cost 1121 can include a column representing a type of procedure involved (e.g., type 1122) and a bar graph portion representing a cost associated with the procedure using bars (e.g., magnitude 1123) such that the higher the cost of a procedure, the longer the bar associated with the procedure. While the bar graph is depicted as a horizontal bar graph, it is understood that a vertical bar graph, a histogram, or any other type of statistical analysis depiction can be used to represent the information depicting a performance metric of a healthcare-related entity. It will also be understood that user interface 1100 can include user-friendly features such that a user can click on magnitude 1123 to toggle between a descending order and an ascending order for the representation. Furthermore, while user interface 1100 shows only the top nine representations on the bar graph, a user can select an option (e.g., more 1129) to increase or decrease the number of depicted representations on the bar graph.

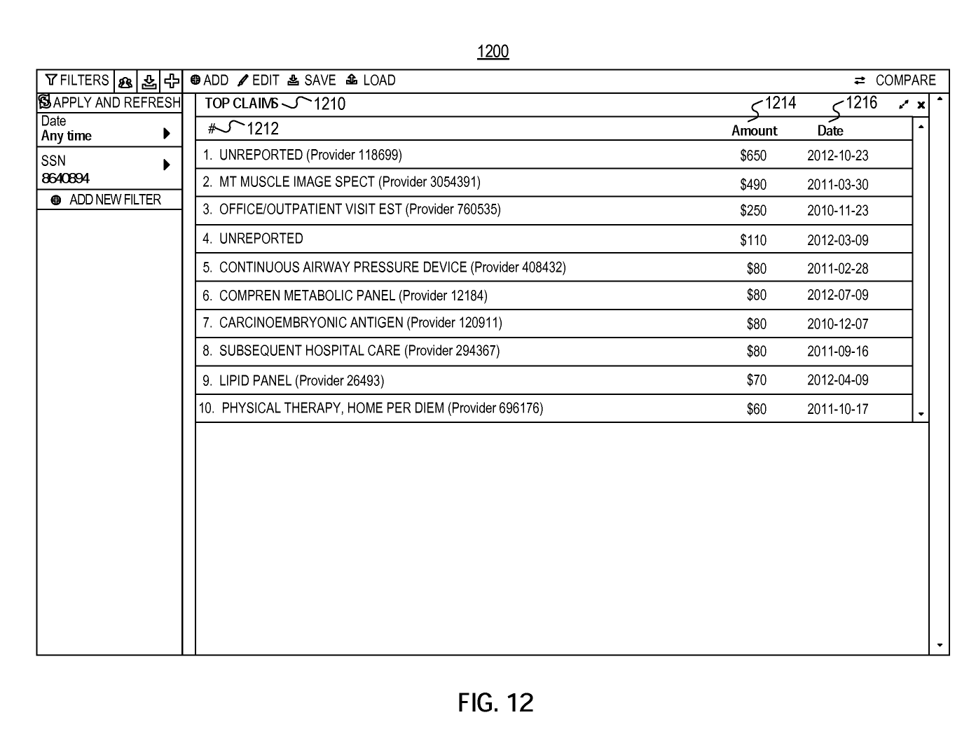

FIG. 12 shows an exemplary user interface 1200 generated by a medical provider entity analysis system (e.g., medical provider entity analysis system 210), according to some embodiments. User interface 1200 includes a table depicting a performance metric of an entity (e.g., member 8640894) for exemplary filter selections (e.g., top claims 1210). The table can represent the interactions associated with member 8640894 and have the highest claim amount involved. For example, top claims 1210 represents the top ten interactions with the highest claim amount that ranges from $650 as the highest claim to $60 as the tenth highest claim. Top claims 1210 includes a column representing a number of the claim (e.g., #1212), a column representing a claim amount (e.g., amount 1214), and a column representing a date of occurrence for the claim (e.g., date 1216).

FIG. 13 shows an exemplary user interface 1300 generated by a medical provider entity analysis system (e.g., medical provider entity analysis system 210), according to some embodiments. User interface 1300 includes bar graphs (e.g., amount bar graph 1310 and count bar graph 1320) depicting a performance metric of a member entity (e.g., member 8640894) for exemplary filter selections, claim amount and claim count. Amount bar graph 1310 shows a representation of claim amount for interactions associated with member 8640894 over time, for example, on a monthly basis. Count bar graph 1320 shows a representation of number of claims for interactions associated with member 8640894 over time, for example, on a monthly basis. These interactions can be between member 8640894 and any medical provider entity. In some embodiments, a filter selection identifying one or more medical provider entities (e.g., provider 104) can be received. In such embodiments, count bar graph 1320 (or amount bar graph 1310) can represent data associated with only those interactions between member 8640894 and provider 104. It is understood that these bar graphs can represent claim amount or claim count associated with interactions over any given periodic intervals (e.g., daily, weekly, monthly, quarterly, yearly etc.).

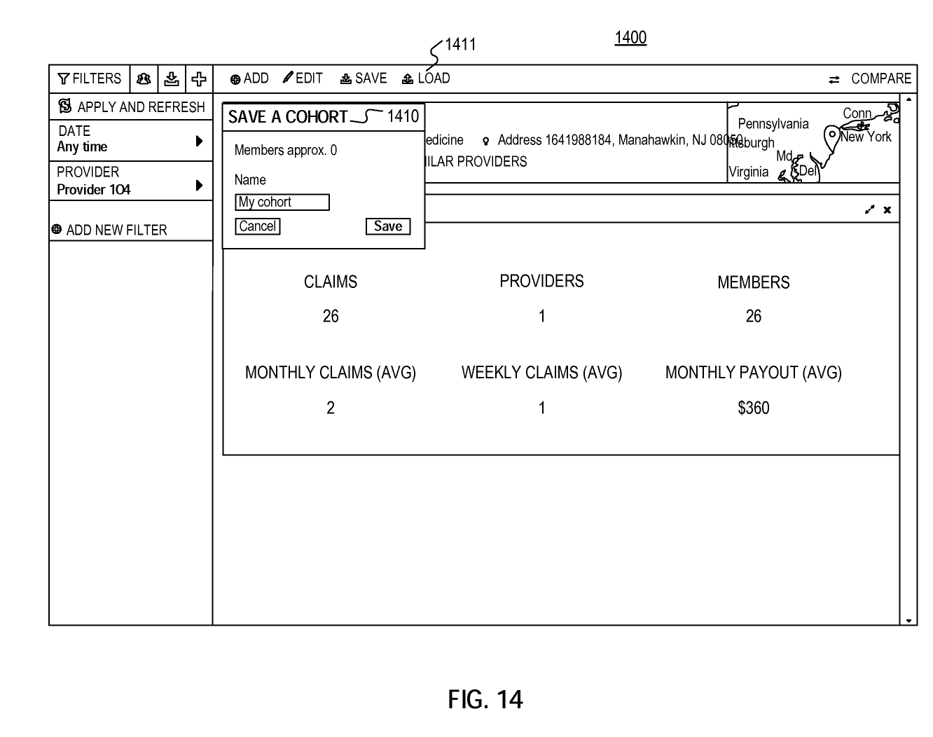

FIG. 14 shows an exemplary user interface 1400 generated by a medical provider entity analysis system (e.g., medical provider entity analysis system 210), according to some embodiments. User interface 1400 includes an option to save a cohort of entities (e.g., save a cohort 1410). Save a cohort 1410 can be defined to include two or more entities that share at least one attribute among themselves. For example, two or more member entities that are male can form a cohort. Similarly, two or more medical provider entities that provide dental services can form a cohort. Save a cohort 1410 can include an option to customize the name of the saved cohort. While user interface 1400 does not explicitly show loading a saved cohort, it is understood that user interface 1400 can also include an option to load a saved cohort (e.g, load 1411). These cohorts allow the user interface 1400 to switch between displaying different types of analyses. For example, the user interface 1400 can be switched between displaying a cohort that includes member entities and a cohort that includes medical provider entities. In some embodiments, the cohorts can be used to determine the intersection or union of entities with shared attributes.

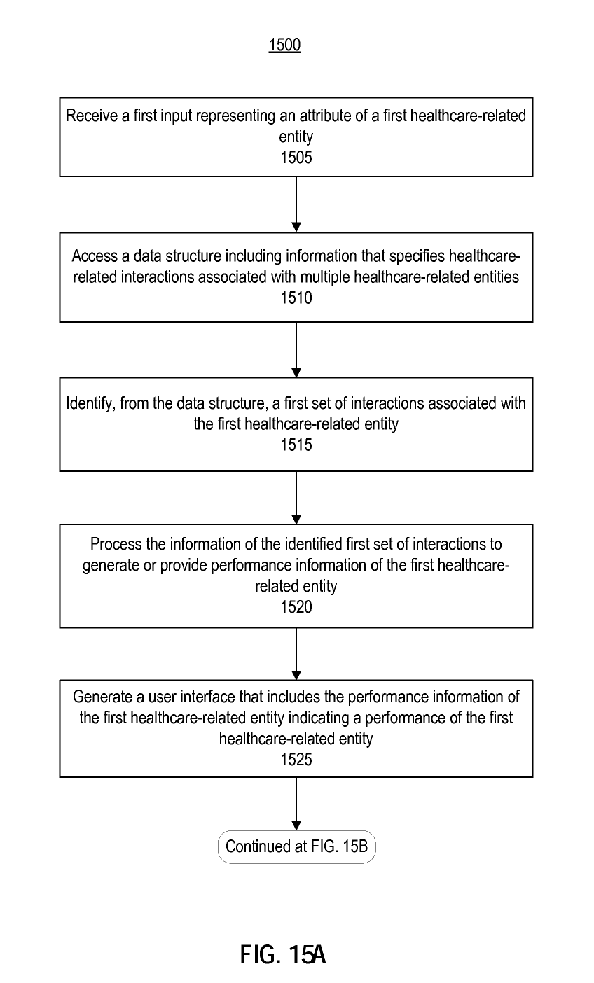

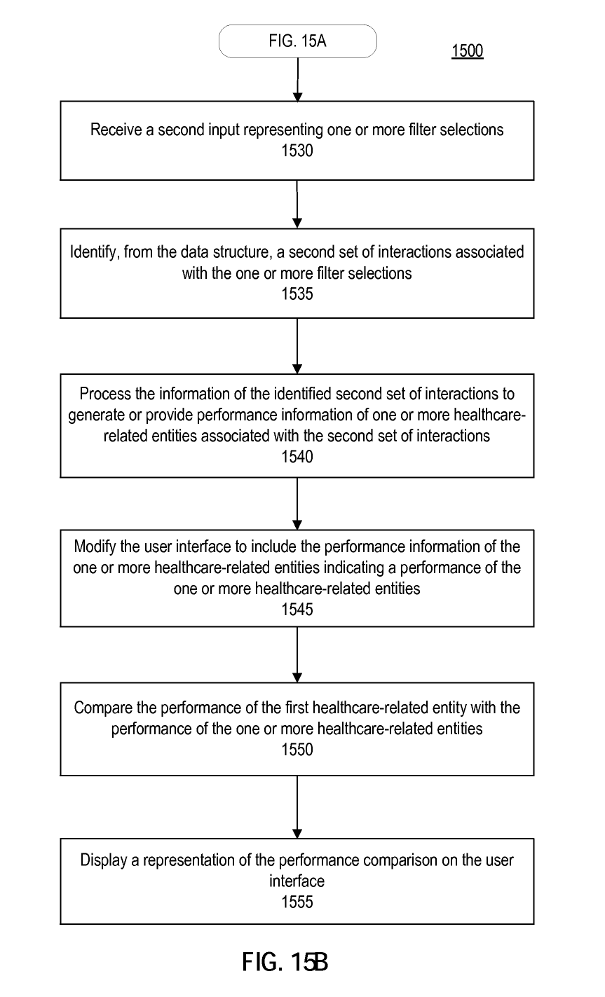

As stated above, one of the objectives for analyzing healthcare-related data is to be able to provide a generalizable platform for analyzing performance of various entities involved in healthcare industry including, medical provider entities, member entities, healthcare insurance provider entities, etc. In some embodiments, fraud associated with medical claims can be detected by analyzing and comparing medical claim data with that of local, regional, and/or national medical claim data. For example, medical claim fraud can be detected by identifying any irregularities associated with medical claims, as described in FIG. 15 below. In some embodiments, an analyst associated with, for example, a healthcare insurance provider entity can use the system to detect any fraud associated with medical claims filed with the healthcare insurance provider entity. The analyst can begin analyzing medical claims based on a user input. For example, a tip can be received from external to the system signifying that a certain medical provider entity is suspected to be involved with inappropriate billing practices. To analyze the received tip, the analyst can access a data structure (e.g., database 170) that includes data associated with all medical claims of the healthcare insurance provider entity. Alternatively, the analyst can begin analyzing medical claims without having to receive an external user input. For example, a pre-determined threshold can be set for a particular billing code associated with a particular specialty of medical provider entity such that when a provider entity's performance exceeds the pre-determined threshold an alert can be sent to the analyst suggesting that an analysis should be performed on interactions associated with the medical provider entity.

FIG. 15 depicts a flowchart representing an exemplary process for analyzing entity performance, consistent with embodiments of the present disclosure. While the flowchart discloses steps in a particular order, it is appreciated that at least some of the steps can be moved, modified, or deleted where appropriate, consistent with the teachings of the present disclosure. Furthermore, while the following steps are performed by a medical provider entity analysis system (e.g., medical provider entity analysis system 210), it is appreciated that some of these steps can be performed in full or in part by other systems (e.g., such as those systems identified above in FIG. 2).

In step 1505, a medical provider entity analysis system can receive a first input representing a first healthcare-related entity to implement a process for comparing a performance of healthcare-related entities. In some embodiments, a medical provider entity (e.g., a hospital) that can be interested in comparing its performance with one or more healthcare-related entities can receive the first input. The first input can comprise one or more filter selections. The one or more filter selections can comprise a selection to represent data associated with at least one of: members; providers; claims; procedures; diagnoses; and time. In some embodiments, the one or more filter selections can comprise a selection to represent data associated with at least one of: charts; histograms; maps; numbers; and time.

In step 1510, the medical provider entity analysis system can access a data structure (e.g., data structure 400) including information that specifies a plurality of categories of information showing healthcare-related interactions associated with multiple healthcare-related entities. The data structure can represent information associated with a very large number of interactions. In some embodiments, the data structure can represent information for tens of millions of healthcare-related interactions (e.g., data structure 400 depicting ten million healthcare-related interactions). The data structure can be similar to the exemplary data structure 400 described in FIG. 4 above.

In step 1515, the medical provider entity analysis system can identify a first set of interactions within the data structure that are associated with the first healthcare-related entity. The first set of identified interactions, for example, can be part of the data structure (e.g., data structure 400). In some embodiments where the first input comprises one or more filter selections, there can be a mapping between the first input filter selections and a plurality of categories of the data structure associated with the first set of interactions. For example, a filter selection representing medical provider entity's location zip code can be mapped to medical provider entity location category 440 and further to zip code sub-category 446. Another exemplary mapping can exist between a filter selection for medical provider entity's specialty and a category or a sub-category associated with a specialty of medical provider entity (element 450 of FIG. 4). It is appreciated that the exemplary mapping techniques described above are merely exemplary and other mapping techniques can be defined within the scope of this disclosure.

For embodiments where one or more filter selections are received, the medical provider entity analysis system (e.g., medical provider entity analysis system 210) can identify relevant categories of the first set of interactions of the data structure based on the received filter selections. For example, if the received filter selection involves a location of a member entity (e.g., member zipcode 815), the medical provider entity analysis system can identify categories associated with a number of interaction (e.g., number category 410), an identity of member entities (e.g., member entity identification category 415), and a location of member entities (e.g., member entity location category 420 including at least zip code sub-category 426). Alternatively, member entity location category 420 can be identified along with one or more categories of state sub-category 422, city sub-category 424, zip code sub-category 426, and street address sub-category 428.

In step 1520, the medical provider entity analysis system can process information associated with the identified first set of interactions to generate or provide performance information of the first healthcare-related entity. In embodiments with received filter selections, performance of the first healthcare-related entity can be analyzed in accordance with the received filter selections. In some embodiments, the first healthcare-related entity can be a single medical provider entity (e.g., a medical clinic). Alternatively, the first healthcare-related entity can comprise one or more groups of healthcare-related entities as identified by the received filter selections. For example, a group of healthcare-related entities can be defined such that the group of entities have similar characteristics, such as all dentist clinics within a given zip code or all pharmacy store locations (e.g., Walgreens™) within a city (e.g., San Jose, Calif.). Processing the identified categories can comprise creating a new data structure that is different from the data structure of step 1510, and comprising only the identified first set of interactions of step 1515 or one or more subsets of the categories comprised in those interactions. Alternatively, processing the identified first set of interactions can be performed on the existing data structure of step 1510 (e.g., data structure 400).

In some embodiments, data associated with identified categories can be stored in either a row-oriented database or a column-oriented database, as described above with respect to data structure 400. Processing information can involve performing statistical analysis on data stored in the identified categories. Performing statistical analysis, for example, can include various computations of data associated with identified categories. For example, if an identified category is interaction amount category 460, processing information can include performing an aggregate of the interaction amount to compute a total amount for all interactions associated with the medical provider entity. It is understood that processing information can include other examples of performing statistical analysis, including but not limited to, computing an average, mean, maximum, minimum, or standard deviation for a series of data.

In some embodiments, the medical provider entity analysis system can process information of a data structure that is updated in real-time. That is, processing of information can occur on the data structure that comprises up-to-date interaction data at the time of processing step 1520. Alternatively, the medical provider entity analysis system can process information of a data structure that is not updated in real-time. That is, processing of information can occur on the data structure that does not comprise up-to-date interaction data at the time of processing step 1520. For example, processing of information can occur on a data structure that is updated only periodically (e.g., on a daily or weekly basis) and not in real-time. In step 1525, the medical provider entity analysis system can generate a user interface that includes the performance information of the first healthcare-related entity indicating a performance of the first healthcare-related entity (e.g., medical provider entity). In some embodiments, user interface of step 1525 can be similar to the user interface described in step 550 above.

After depicting a performance of the first healthcare-related entity, the method can proceed with a series of steps for comparing the performance of the first entity with either a second entity or a group of healthcare-related entities. To assist with the comparison, in step 1530, the medical provider entity analysis system can receive a second input representing one or more filter selections. In some embodiments, the second input can be received from a medical provider entity (e.g., a hospital). The second input filter selections can comprise a selection to represent data associated with at least one of: members; providers; claims; procedures; diagnoses; and time. Alternatively, the second input filter selections can comprise a selection to represent data associated with at least one of: charts; histograms; maps; numbers; and time. In embodiments where the first input comprises a first set of filter selections, the second input comprises a second set of filter selections. Alternatively, in some embodiments, the second input filter selections can be the same as the first input filter selections.

In some embodiments, the second input filter selections can comprise a selection to represent data associated with at least one of: demographic information representing at least one of age, gender, income, social security number, and location associated with the member entity; information representing the medical provider entity's location; information representing the medical provider entity's identification; information representing the medical provider entity's specialty; information representing an amount associated with an interaction; information representing a medical diagnosis associated with an interaction; information representing a medical procedure associated with an interaction; and a time associated with an interaction.

In step 1535, the medical provider entity analysis system can identify a second set of interactions within the data structure based on the second input filter selections. The second set of identified interactions, for example, can be part of the data structure (e.g., data structure 400). In some embodiments, there can be a mapping, similar to the mapping described in step 1515, between the second input filter selections and a plurality of categories of the data structure associated with the second set of interactions.

Based on the second input filter selections, the medical provider entity analysis system can identify some categories of the second set of interactions of the data structure that are relevant for comparing the performance of the first healthcare-related entity with one or more other entities. For example, the medical provider entity analysis system can identify categories, similar to the identified categories described in step 1515, associated with a number of interaction (e.g., number category 410), an identity of member entities (e.g., member entity identification category 415), and a location of member entities (e.g., member entity location category 420 including at least zip code sub-category 426). In some embodiments, member entity location category 420 can be identified along with one or more categories of state sub-category 422, city sub-category 424, zip code sub-category 426, and street address sub-category 428.

In step 1540, the medical provider entity analysis system can process information associated with the identified second set of interactions to generate or provide performance information of a second healthcare-related entity associated with the second set of interactions. In some embodiments, the second healthcare-related entity can be a group of entities that share an attribute (e.g., cohort). Processing of information of step 1540 can be similar to the processing of information described in step 1520 above. In step 1545, the medical provider entity analysis system can generate a user interface (or modify user interface of step 1525) to include the performance information of the second healthcare-related entity (or a group of healthcare-related entities) indicating a performance of the second healthcare-related entity (or the group of healthcare-related entities) on the same user interface as in step 1525.

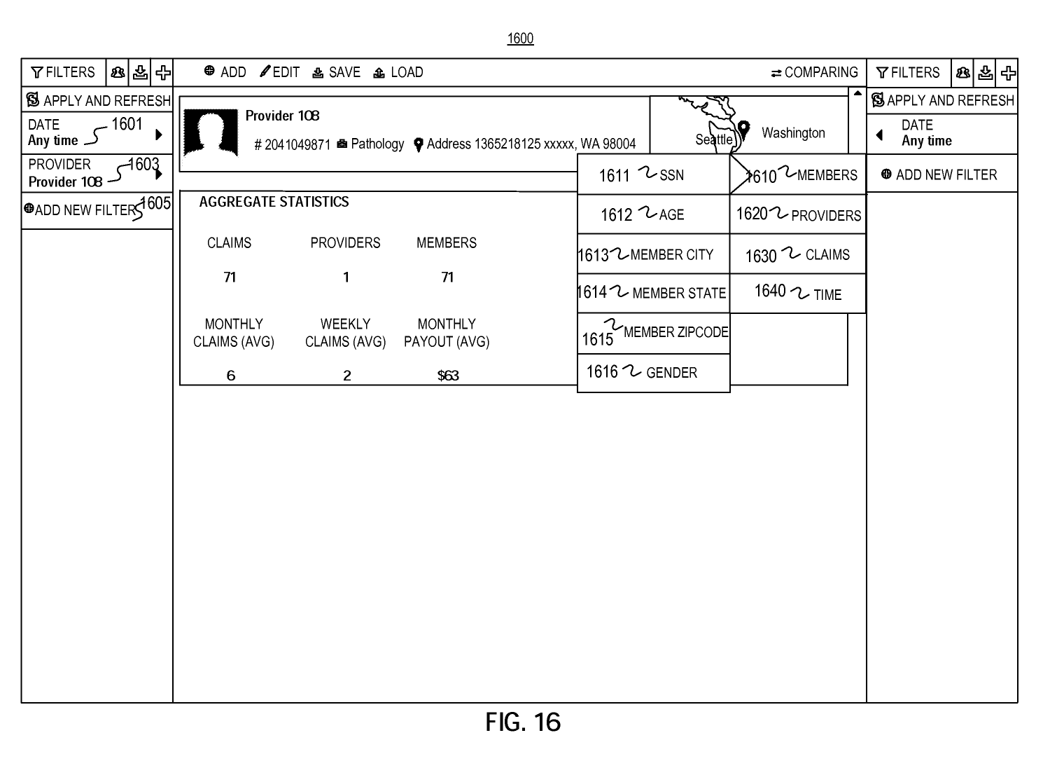

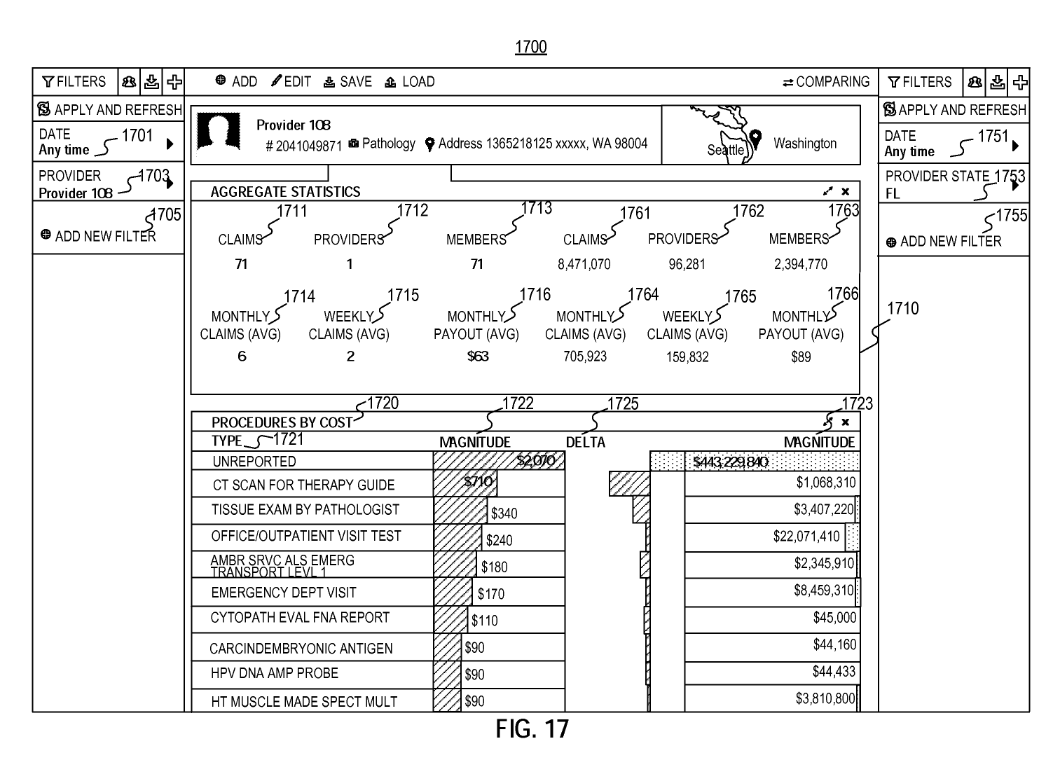

In step 1550, the medical provider entity analysis system can compare the performance of the first healthcare-related entity with the performance of the second healthcare-related entity (or a group of healthcare-related entities). In some embodiments, the second healthcare-related entity (or a group of healthcare-related entities) can be identified based on the second input filter selections. In step 1555, the medical provider entity analysis system can display a representation of a performance comparison between the first healthcare-related entity and that of the second healthcare-related entity (or a group of healthcare-related entities) on the user interface. For example, a first healthcare-related entity (e.g., an health insurance payer) can be interested in analyzing billing practices of a specific doctor (e.g., a pathologist with an identification, provider 108 of FIG. 16) and compare a performance of provider 108 with other pathologists (a group of entities) located within a proximity of provider 108. For the health insurance payer, an analyst typically analyzes billing practices to evaluate regulatory compliance and to also identify any fraud associated with the billing practices. In some embodiments, the analyst can receive a tip that certain pathologists (e.g., provider 108) are known for inappropriate billing practices. To evaluate the billing practices of provider 108, the analyst can employ the system to provide a first input identifying provider 108. Next, as described above in steps 1510 through 1525, a performance of provider 108 can be depicted on a user interface. For example, as shown in FIG. 17, a user interface 1700 depicts a performance of provider 108 that can be generated by a medical provider entity analysis system (e.g., medical provider entity analysis system 210), according to some embodiments.

For purposes of illustration, assume a situation where an analyst is evaluating billing practices of provider 108. In such a case, user interface 1700 can include a user interface element to add one or more filter selections (e.g., add new filter 1705 and add new filter 1755). User interface 1700 can include a user interface element to display a time period (e.g., date 1701 and date 1751) associated with a performance metric depicted in FIG. 17. User interface 1700 can also include a user interface element to display an identity of an entity (e.g., provider 1703 and provider state 1753) whose performance can be analyzed and can be depicted. In the present example, provider 1703 can be used to display an identity of the first healthcare-related entity, provider 108. Provider state 1753, as discussed below, can be a part of second filter selections such that interactions associated with the state of Florida can be analyzed for a performance comparison of the first entity, provider 108.

In some embodiments, a performance associated with all interactions with provider 108 can be displayed in an exemplary dashboard (e.g., dashboard 1710 of user interface 1700). Dashboard 1710 can include a performance summary of medical provider entity, provider 108, that includes a number of claims (e.g., claims 1711), a number of medical provider entities (e.g., providers 1712), a number of member entities (e.g., members 1713), average number of claims in a month (e.g., monthly claims (AVG) 1714), average number of weekly claims (e.g., weekly claims (AVG) 1715), and average payout on a monthly basis (e.g., monthly payout (AVG) 1716).

User interface 1700 can also include a bar graph for depicting a performance of provider 108. For example, user interface 1700 includes procedures by cost bar graph 1720 that depicts various procedures involved with provider 108 in a descending order of a cost associated with the procedures. Procedures by cost bar graph 1720 can further include a column representing a type of procedure involved (e.g., type 1721) and a bar graph portion representing a cost associated with the procedures using bars (e.g., magnitude 1722) such that the higher the cost of a procedure, the longer the bar associated with the procedure. For example, type 1721 represents “CT Scan for Therapy Guide” as the procedure with the second highest cost and is depicted as the second longest bar in the bar graph.

Next, as detailed in step 1530, the medical provider entity analysis system can receive a second input representing one of more filter selections to enable a performance comparison between provider 108 and a group of healthcare-related entities. For example, the second input can be received by selecting add new filter 1755 as depicted in user interface 1700. The possible filter selections of add new filter 1755 can be similar to all possible values as described in steps 1515 and 1530. An exemplary second input filter selection can be depicted by provider state 1753 in user interface 1700. In this example, provider state 1753 indicates a value as FL, signifying that a state of a medical provider entity as Florida. Accordingly, in step 1535, a second set of interactions can be identified that are associated with all medical providing entities that are located in the state of Florida. Then in step 1540, the identified second set of interactions can be analyzed to evaluate a performance of all entities associated with the second input filter selections, i.e., entities located in Florida. For example, user interface 1700 depicts dashboard 1710 that also includes a performance summary of the second set of interactions based on the second input filter selections (e.g., provider state 1753 of Florida). In this example, the performance summary includes number of claims (e.g., claims 1761), a number of medical provider entities (e.g., providers 1762), a number of member entities (e.g., members 1763), average number of claims in a month (e.g., monthly claims (AVG) 1764), average number of weekly claims (e.g., weekly claims (AVG) 1765), and average payout on a monthly basis (e.g., monthly payout (AVG) 1766).

It is understood that dashboard 1710 can provide a simplified side-by-side performance comparison between first healthcare-related entity and a second healthcare-related entity. In some embodiments, the second entity can be two or more healthcare-related entities or a cohort of healthcare-related entities (e.g., save a cohort 1410). For example, dashboard 1710 depicts total claims associated with provider 108 to be 71 (as identified by element 1711) while the total claims associated with medical providing entities located in Florida to be 8,471,010 (as identified by element 1761). This comparison can provide a quick overview of how many claims provider 108 is processing compared to all such providers in the state of Florida. While the above-described second input filter selections refer to a state, tt will be understood that by changing the second input filter selections to a zip code, for example, element 1761 can indicate the total number of claims processed within that particular zip code.

User interface 1700 also shows procedures by cost for the first healthcare-related entity (in this case provider 108) as compared to an aggregate group of medical provider entities. In the procedures by cost 1720 portion of this exemplary bar graph, the left hand side shows the types of procedures (e.g., type 1721) and their costs of interactions associated with provider 108 (e.g., magnitude 1722). On the right hand side, the costs for those procedures as provided by an aggregate group of medical providers are shown (e.g., magnitude 1723). While FIG. 17 shows the total costs for each of the procedures, it is appreciated that the displayed cost can be normalized per each performance of that procedure.

The aggregate group of medical providers could be local, regional, or national medical provider entities that are the same or are similar to the medical provider entity at issue (in this case, provider 108). The aggregate group of medical providers can be identified based on the second input filter selections (e.g., filter selection 1753 for Florida). Delta chart 1725 in the middle of the two procedures by cost portion shows a comparison between provider 108's cost of procedure versus the aggregate group of medical providers' normalized cost of the same procedure. For example, for the CT Scan for Therapy Guide procedure, the cost of this procedure as compared between provider 108 and the aggregate group of medical provider entities leaned heavily towards the medical provider entity, thereby providing an indication that further investigation may be needed. On the other hand, the costs for the Office/Outpatient Visit Est procedures were similar between provider 108 and the aggregate group of medical provider entities, thereby providing an indication that further investigation might not be needed. It is understood that the above-described method for analyzing and comparing entity performance to identify fraud is only exemplary and not meant to be limiting.

FIG. 16 shows an exemplary user interface 1600 generated by a medical provider entity analysis system (e.g., medical provider entity analysis system 210), according to some embodiments. User interface 1600 includes an option to add one or more filters (e.g., add new filter 1605). In some embodiments, the option to add one or more filters can include, similar to FIGS. 7 and 8, adding filters related to interactions associated with member entities (e.g., members 1610), medical provider entities (e.g., providers 1620), medical claims (e.g., claims 1630), and a time of the occurrence of the interactions (e.g., time 1640).

User interface 1600 can also depict sub-filter selections that can be associated with a filter selection. For example, user interface 1600 can depict sub-filter selections associated with member entities (e.g., members 1610) that can include a selection associated with member entity's identification (e.g., SSN 1611 that can represent a social security number), member entity's age (e.g., age 1612), member entity's city (e.g., member city 1613), member entity's state (e.g., member state 1614), member entity's zip code (e.g., member zipcode 1615), and member entity's gender (e.g., gender 1616). It is understood that sub-filter selections associated with other filter selections (e.g., providers 1620, claims 1630, and time 1640) can be included within user interface 1600 such that each such filter selection can have sub-filter selections similar to that of filter selection, members 1610. For example, providers 1620 can include sub-filter selections (not shown in FIG. 16) comprising entity identification and entity location.

Moreover, using a similar type of analysis as shown in, for example, FIG. 17, fraud associated with prescription medicine and/or pharmaceutical drugs can also be detected. Medical provider entity analysis system 210 can analyze interactions associated with pharmacy claims to identify useful insights including an ability to detect any irregularities such as fraud. An exemplary use case associated with analyzing pharmacy interactions can include identifying all pharmacies with a revenue above a threshold (e.g., more than say $100,000 per year) in a given region (e.g., Florida) and then displaying a histogram of a specific type of drugs (e.g., schedule 2 drugs such as narcotics) sold by the pharmacy. In the same use case scenario, a user can select an option to display a histogram depicting “drugs prescribed” to analyze a correlation between a histogram depicting the sales of schedule 2 drugs and the histogram depicting drugs prescribed. Such a correlative analysis can be useful in analyzing whether any suspicious activity can be associated with the pharmacy. Another use case can be to depict top prescribing entities associated with the pharmacy.

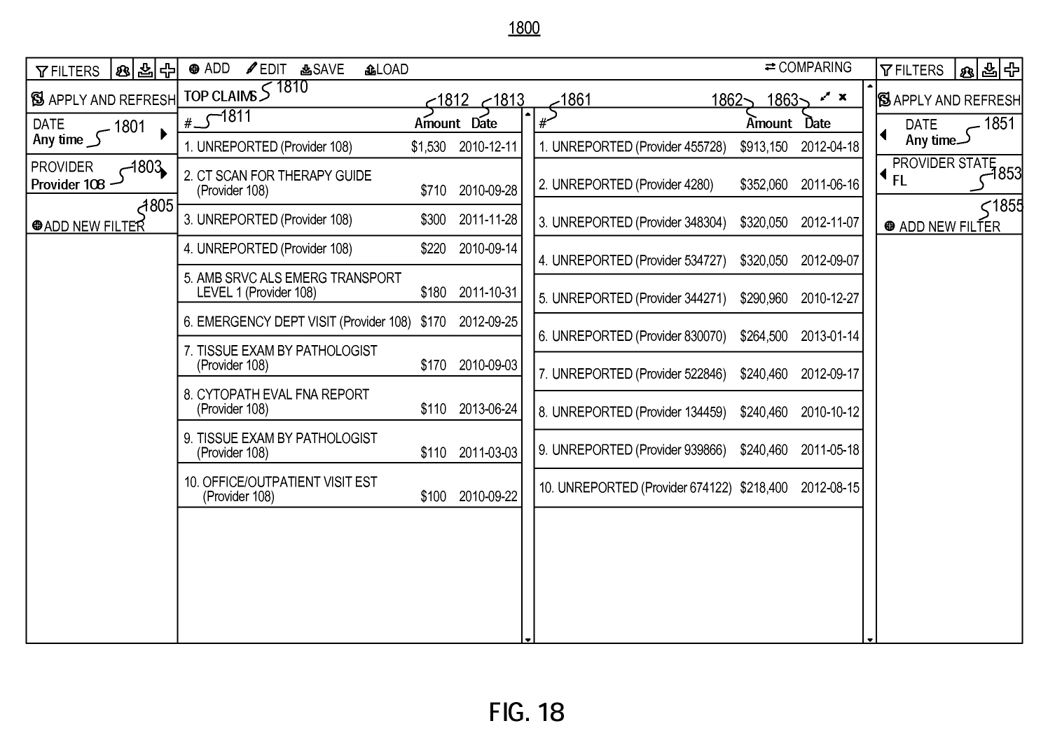

FIG. 18 shows an exemplary user interface 1800 generated by a medical provider entity analysis system (e.g., medical provider entity analysis system 210), according to some embodiments. User interface 1800 can, similar to FIG. 17, include an option to add one or more filter selections (e.g., add new filter 1805 and add new filter 1855), a user interface element to display a time period (e.g., date 1801 and date 1851), and another user interface element to display an identity of an entity (e.g., provider 1803 and provider state 1853). User interface 1800 includes a tabular chart depicting a top claims associated with a first healthcare-related entity on the left side (e.g., top claims 1810 with columns 1811-1813). On the right side of top claims 1810 tabular chart is a portion of the chart depicting top claims associated with an aggregate of entities included in a set of interactions occurring in the state of Florida (as exemplified by provider state 1853 representing Florida). In this example, a provider with the top claims in the state of Florida, provider 455728, as depicted by element 1861, shows that the total amount of all claims processed by that provider as $913,150. This amount can be compared with the total amount of claims processed by the first healthcare-related entity, provider 108. Such a comparison would indicate how provider 108 is processing claims relative to the highest processor of claims (by aggregate claim amount for example) in the state of Florida. While the above-described example refers to an aggregate claim amount (element 1862), it will be understood that the aggregate claim amount can be normalized based on the number of claims included in the aggregate to result in an average claim amount for each provider. A comparison between providers based on an average claim amount can provide, in some embodiments, another insight relative to any potential fraud associated with a provider.

It is understood that a user interface similar to interfaces 1700 and/or 1800 can be generated to depict top prescribing entities. While FIG. 18 depicts top claims associated with medical provider entities (of column #1861) that provide medical consultation services for member entities, FIG. 18 can also depict top claims associated with medical provider entities that prescribe drugs for member entities. In such an embodiment, column #1861 can show a list of providers that prescribe the most number of prescription drugs for the given set of filter selections. Yet another use case can be to compare a performance of a first pharmacy with other pharmacies in the same region (e.g., cohort pharmacies within same zip code, city, county, state, etc.). While the above user interfaces refer to top prescribing entities and cohort pharmacies, it is appreciated that similar user interfaces can be generated within the scope of this disclosure to depict a comparison of pharmacy claims and prescription drug costs as described above.

Medical provider entity analysis system 210 can perform cohort analysis of interactions to detect any irregularities including fraud. A cohort can be defined, saved, and loaded from memory as described in FIG. 14 above. An exemplary use case can begin with identifying a medical provider entity that is known to be associated with fraudulent practices (“known bad entity”) and that is currently out of business. The system can analyze a timeline to identify a time period prior to when the known bad entity closed its business to perform cohort analysis. For the selected time period, a selection can be made to filter all interactions associated with the known bad entity that also involve schedule 2 drugs (e.g., narcotics). Next, a cohort can be defined comprising all relevant member entities associated with the filtered interactions. By using the defined cohort of member entities, an analysis can be run to identify top provider entities associated with the cohort after the point in time when the known bad entity was shut down. Such an analysis can help in identifying any other potential bad entities that might still be in operation. One method of identifying such potential bad entities can be to look for the providers with the most number of interactions associated with the cohort. Alternatively, potential bad entities can be identified based on a frequency of prescription interactions and/or pharmacy interactions associated with the cohort group. After such potential bad entities have been identified, the system can analyze interactions associated with these potential bad entities further to identify any suspicious or fraudulent activity. It is appreciated that other methods of identifying potential bad entities and their fraudulent practices are possible within the scope and spirit of this disclosure.

In the foregoing specification, embodiments have been described with reference to numerous specific details that can vary from implementation to implementation. Certain adaptations and modifications of the embodiments described herein can be made. Therefore, the above embodiments are considered to be illustrative and not restrictive.

1. A system for analyzing healthcare-related entity performance, the system comprising:
a memory device that stores a set of instructions;
one or more processors configured to execute the set of instructions in order to:
receive a request that includes one or more filter selections;
access a data structure including information that specifies healthcare-related interactions associated with multiple healthcare-related entities;
identify, from the data structure, a first set of interactions associated with a first healthcare-related entity;
use the information of the identified first set of interactions to provide performance information of the first healthcare-related entity;
identify, from the data structure, a second set of interactions associated with the one or more filter selections, wherein the one or more filter selections are mapped to one or more of the healthcare-related interactions;
use the information of the identified second set of interactions to provide performance information of one or more healthcare-related entities corresponding with the second set of interactions; and
generate a user interface that includes the performance information of the first healthcare-related entity and the performance information of the one or more healthcare-related entities representing a performance of the first healthcare-related entity and a performance of the one or more healthcare-related entities respectively.

2. The system of claim 1, wherein the one or more processors are further configured to:
compare the performance of the first healthcare-related entity with the performance of the one or more healthcare-related entities; and
display a representation of the performance comparison on the user interface.

3. The system of claim 1, wherein each of the healthcare-related interactions comprises categories of information including at least one of:
an interaction number category;
a member entity identification category;
a member entity location category;
a medical provider entity identification category;
a medical provider entity location category;
a specialty of medical provider entity category;
a medical procedure category;
a medical diagnosis category;
an interaction amount category; and
a time of interaction category.

4. The system of claim 1, wherein the user interface includes a dashboard showing a graphical representation of at least one of the performance of the first healthcare-related entity and the performance of the one or more healthcare-related entities.

5. The system of claim 1, wherein the user interface includes an option to save a graphical representation of the performance of the first healthcare-related entity and/or the performance of the one or more healthcare-related entities.

6. The system of claim 1, wherein the user interface includes an option to load a previously saved graphical representation of the performance of the first healthcare-related entity and/or the performance of the one or more healthcare-related entities.

7. The system of claim 1, wherein the healthcare-related interactions are associated with at least one of pharmaceutical interactions, prescription medicine interactions, and medical claims interactions.

8. The system of claim 1, wherein the first healthcare-related entity is known to be associated with fraudulent practices and wherein the second set of interactions can be analyzed to identify potential fraud associated with at least one of the one or more healthcare-related entities.

9. The system of claim 8, wherein the potential fraud is identified by identifying a healthcare-related entity that is associated with the most number of interactions within the second set of interactions.

10. A method for analyzing healthcare-related entity performance, the method being performed by one or more processors and comprising:
receiving a request that includes one or more filter selections;
accessing a data structure including information that specifies healthcare-related interactions associated with multiple healthcare-related entities;
identifying, from the data structure, a first set of interactions associated with a first healthcare-related entity;
using the information of the identified first set of interactions to provide performance information of the first healthcare-related entity;
identifying, from the data structure, a second set of interactions associated with the one or more filter selections, wherein the one or more filter selections are mapped to one or more of the healthcare-related interactions;
using the information of the identified second set of interactions to provide performance information of one or more healthcare-related entities associated corresponding with the second set of interactions; and
generating a user interface that includes the performance information of the first healthcare-related entity and the performance information of the one or more healthcare-related entities representing a performance of the first healthcare-related entity and a performance of the one or more healthcare-related entities respectively.

11. The method of claim 10, further comprising:
comparing the performance of the first healthcare-related entity with the performance of the one or more healthcare-related entities; and
displaying a representation of the performance comparison on the user interface.

12. The method of claim 10, wherein the user interface includes an option to save a graphical representation of at least one of the performance of the first healthcare-related entity and the performance of the one or more healthcare-related entities.

13. The method of claim 10, wherein the user interface includes an option to load a previously saved graphical representation of the performance of the first healthcare-related entity and/or the performance of the one or more healthcare-related entities.

14. The method of claim 10, wherein the health care-related interactions are associated with at least one of pharmaceutical interactions, prescription medicine interactions, and medical claims interactions.

15. The method of claim 10, wherein the first healthcare-related entity is known to be associated with fraudulent practices and wherein the second set of interactions can be analyzed to identify potential fraud associated with at least one of the one or more healthcare-related entities.

16. The method of claim 15, wherein the potential fraud is identified by identifying a healthcare-related entity that is associated with the most number of interactions within the second set of interactions.

17. A non-transitory computer-readable medium storing a set of instructions that are executable by one or more processors of one or more servers to cause the one or more servers to perform a method for analyzing healthcare-related entity performance, the method comprising:
receiving a request that includes one or more filter selections;
accessing a data structure including information that specifies healthcare-related interactions associated with multiple healthcare-related entities;
identifying, from the data structure, a first set of interactions associated with a first healthcare-related entity;
using the information of the identified first set of interactions to provide performance information of the first healthcare-related entity;
identifying, from the data structure, a second set of interactions associated with the one or more filter selections, wherein the one or more filter selections are mapped to one or more of the healthcare-related interactions;
using the information of the identified second set of interactions to provide performance information of one or more healthcare-related entities associated corresponding with the second set of interactions; and
generating a user interface that includes the performance information of the first healthcare-related entity and the performance information of the one or more healthcare-related entities representing a performance of the first healthcare-related entity and a performance of the one or more healthcare-related entities respectively.

18. The computer-readable medium of claim 17 further comprising:
comparing the performance of the first healthcare-related entity with the performance of the one or more healthcare-related entities; and
displaying a representation of the performance comparison on the user interface.

19. The computer-readable medium of claim 17, wherein the first healthcare-related entity is known to be associated with fraudulent practices and wherein the second set of interactions can be analyzed to identify potential fraud associated with at least one of the one or more healthcare-related entities.

20. The computer-readable medium of claim 19, wherein the potential fraud is identified by identifying a healthcare-related entity that is associated with the most number of interactions within the second set of interactions.
